(19) United States
(12) Patent Application Publication
(10) Pub. No.: US 2006/0178457 A1
(43) Pub. Date: Aug. 10, 2006

(54) Optical members and polymerizable compositions and thio compounds for producing them

(76) Inventors: Hiroki Sasaki, Kanagawa (JP); Talayasu Yasuda, Kanagawa (JP); Seiji Hatano, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/540,926

(22) PCT Filed: Jan. 6, 2004
(86) PCT No.: PCT/JP04/00016

§ 371 Date: Apr. 5, 2006

(30) Foreign Application Priority Data
Jan. 6, 2003 (JP) 2003-000522
Feb. 6, 2003 (JP) 2003-029556

(51) Int. Cl. C08K 5/34

(52) U.S. Cl. 524/100

(57) ABSTRACT

Disclosed is an optical material comprising a matrix formed of a polymer and at least a compound selected from a group denoted by a formula (1a) or formula (2a), wherein R^{1a}, R^{2a} and R^{3a} respectively denote an optionally substituted alkyl group; R^{4a} and R^{4a} respectively denote an optionally substituted alkyl group; and L^{1a} to L^{5a} respectively denote a hydrogen atom, a halogen atom, an optionally substituted alkyl group or the like provided that at least two of L^{1a}, L^{2a}, L^{3a}, L^{4a} and L^{5a} denote a halogen atom, an optionally substituted alkyl group, an optionally substituted alkoxy group or an optionally substituted alkylthio group.

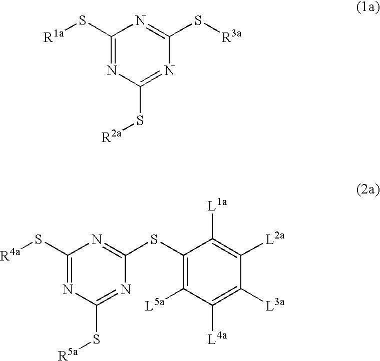

### TECHNICAL FIELD

The present invention relates to polymerizable compositions used for producing optical members, graded index optical members produced by using the composition and novel thio compounds useful as an agent for adjusting refractive index. The present invention also relates to plastic optical members such as optical fibers, light guides or optical lenses, and polymerizable compositions and processes used for producing thereof.

### RELATED ART

In recent years, plastic optical members are being widely used for various applications including optical fibers, light guides and optical lenses, by virtue of its advantages such that allowing more simple producing and processing at a lower cost as compared with quartz-base optical members having the same structure. A plastic optical fiber is slightly inferior to a quartz-base fiber since the entire region of the element fiber thereof is made of plastic material and has, as a consequence, a little larger transmission loss, but superior to the quartz-base optical fiber in that having an excellent flexibility, lightweight property, workability, better applicability in producing a large bore diameter fiber and a lower cost. The plastic optical fiber is thus studied as a transmission medium for optical communication which is effected over a distance relatively as short as allowing such large transmission loss to be ignored (ref. pages from 1 to 8 of “Plastic Optical Fiber” published by KYORITSU SHUPPAN CO., LTD. in 1997, and edited by POF Consortium).

The plastic optical fiber generally has a center core (referred to as “core region” in the specification) made of an organic compound composition, whose matrix is made of a polymer composition, and an outer shell (referred to as “clad region” in the specification) made of an organic compound composition having a refractive index differing from (generally lower than) that of the core region. In particular, the plastic optical fiber having a graded refractive index along the direction from the center to the outside thereof, namely a GI type plastic optical fiber, recently attracts a good deal of attention as an optical fiber which can ensure a high transmission capacity. As one method for producing such plastic optical fibers, it has been proposed a process comprising forming a fiber base member (referred to as “preform” in the specification) according to an interfacial gel polymerization and then drawing the preform (Ref. pages from 66 to 72 of “Plastic Optical Fiber” published by KYORITSU SHUPPAN CO., LTD. in 1997, and edited by POF Consortium; Japanese Patent No. 3332922 (WO93/08488) or the like).

Optical transmitters are required to have little transmission loss and to have a high transmitting capacity. It is understood that refractive-index-distributed optical transmitters exhibit broad transmission band, however, refractive-index-distributed structures cannot always provide improvement of transmission band. For example, as described in “Polymer Journal, vol. 28, p. 272˜275”, it is necessary to adjust the refractive-index-distributed structures and to make enough difference in refractive indexes between the core and clad region in order to obtain broad transmission band. Therefore, the core region often comprises not only a matrix material but also a dopant having a different refractive index from that of the matrix. There has bee provided various dopants such as compounds disclosed in WO93/08488 or the like. By use of the such dopants, a certain improvement in optical characteristics mentioned above can be obtained, however, since optical transmitters are used in practice under various environments, optical transmitters are required to have not only excellent optical characteristics mentioned above but also enough good mechanical characteristics and thermo-stability to be proof against various environments. Furthermore, optical transmitters are required to keep excellent optical characteristics even if they are transformed such as bending, since they are sometimes received external force in practice. Under such circumstances, aromatic sulfides are disclosed as an improved dopant in thermostability in JPA No. 2002-236222 the term “JPA” as used herein means an “unexamined published Japanese patent application). However, such dopants exhibit absorptions attributed to low overtones of C—H bond stretching vibration, and such absorptions could be one of the contributing factors in worsening transmission loss of 850 nm light.

There has been not yet provided optical transmitters having excellent optical characteristics, mechanical characteristics and thermo-stability enough for use in practice.

As mentioned above, optical transmitters are required to have little transmission loss and to have a high transmitting capacity. Especially, when plastic optical fibers are used with a light source emitting near-IR light such as 850 nm, an absorption attributed to overtone of stretching vibration of interatomic bonds is a factor responsible for increasing transmission loss. It has been known that an absorption attributed to overtone of C—H bond stretching vibration, which constitutes a matrix material of an plastic optical fiber, contributes to worsening transmission loss, and it has been often carried out replacing H atoms with heavier atoms such as deuterium or fluorine atoms (Ref. JPA No. 1999-167030). Regarding known compounds which are added to the matrix materials in order to adjust a distribution of refractive index and ensure a sufficient difference in refractive index between a core and clad regions, referred to as “adjuster of refractive index” or “dopant”, almost all are compounds having at least one benzene ring. In order to reduce the transmission loss, some of hydrogen atoms in the matrix material would be replaced with fluorine atoms, and as the replacement ratio would be increased, the resolvability of such a dopant in the matrix material would significantly lower. Therefore, it is necessary to improve not only matrix materials but also dopants. There is a strategy such that dopant having an increased ratio of fluorine atoms would be used, however, there would be a small difference in refractive index between the dopant and the matrix. Especially, the refractive index of poly fluorine-containing methyl methacrylate is about 1.4, which is larger by about 0.1 than those of other fluorine-containing polymers. Thus, using poly fluorine-containing methyl methacrylate as a matrix material may lower a difference in refractive index between the dopant and the matrix material, and thereby may worsen a transmitting capacity. On the other hand, poly fluorine-containing methyl methacrylate has the advantageous of being available at lower-cost as compared with other fluorine-containing polymers, and GI-type optical members could be easily produced by gel-polymerization of fluorine-containing methyl methacrylate. Thus, it has been required to provide dopants compatible with poly fluorine-containing methyl methacrylate. Some aromatic sulfides have been provided as a dopant in JPA No. 2002-236222, however, some of them don't have a sufficient compatibility with matrixes formed of fluorine-containing polymers.

### SUMARRY OF THE INVENTION

One object of the present invention is to provide polymerizable compositions capable of forming optical members having low transmission loss and high thermostability. Other object of the present invention is to provide optical members having low transmission loss and high thermostability. Other object of the present invention is to provide novel thio compounds useful as an adjuster of refractive index used in producing optical members.

Other object of the present invention is to provide polymerizable compositions, containing fluorine-containing methyl methacrylate, having low transmission loss at 850 nm and a large transmitting capacity. Other object of the present invention is to provide fluorine-containing methyl methacrylate base optical members having low transmission loss at 850 nm and a large transmitting capacity.

The present inventors conducted various studies of dopants and as a result, they found that specific thio compounds can be used as a dopant, and that using such dopants, the optical properties of optical members can be improved. And triazine derivatives are soluble in fluorine-containing methyl methacrylate base polymers and have a refractive index sufficiently different from those of the fluorine-containing polymers. On the basis of these findings, the present invention was achieved.

In one aspect, the present invention provides an optical material comprising a matrix formed of a polymer and at least a compound selected from a group denoted by a formula (1a) or formula (2a);

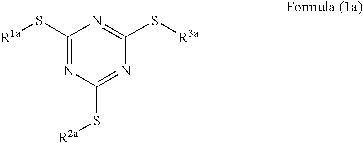

wherein R^{1a}, R^{2a} and R^{3a} respectively denote an optionally substituted alkyl group;

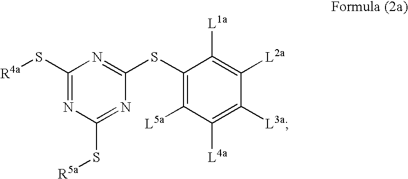

wherein R^{4a} and R^{5a} respectively denote an optionally substituted alkyl group; and L^{1a}, L^{2a}, L^{3a}, L^{4a} and L^{5a} respectively denote a hydrogen atom, a halogen atom, an optionally substituted alkyl group, an optionally substituted alkoxy group or an optionally substituted alkylthio group provided that at least two of L^{1a}, L^{2a}, L^{3a}, L^{4a} and L^{5a} denote a halogen atom, an optionally substituted alkyl group, an optionally substituted alkoxy group or an optionally substituted alkylthio group.

As embodiments of the present invention, the optical material wherein the compound denoted by the formula (1a) or the formula (2a) having at least one fluorine atom; and the optical material used for a plastic optical fiber are provided.

In another aspect, the present invention provides a polymerizable composition for producing an optical member comprising;

a polymerizable monomer composition and

at least a compound, having a different refractive index from that of the polymerizable monomer composition, which is selected from the group denoted by the formula (1a) or the formula (2a); an optical member produced by polymerization of the polymerizable composition, to form a region having a graded refractive index; the optical member wherein the region having a graded refractive index along the direction from the center to the outside; and an optical fiber produced by drawing the optical member.

In another aspect, the present invention provides a compound denoted by a formula (2a);

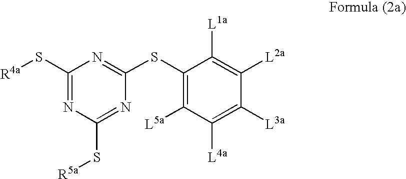

wherein R^{4a} and R^{5a} respectively denote an optionally substituted alkyl group; and L^{1a}, L^{2a}, L^{3a}, L^{4a} and L^{5a} respectively denote a hydrogen atom, a halogen atom, an optionally substituted alkyl group, an optionally substituted alkoxy group or an optionally substituted alkylthio group provided that at least two of L^{1a}, L^{2a}, L^{3a}, L^{4a} and L^{5a} denote a halogen atom, an optionally substituted alkyl group, an optionally substituted alkoxy group or an optionally substituted alkylthio group; and a compound denoted by a formula (3a);

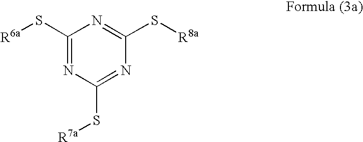

wherein R^{6a}, R^{7a} and R^{8a} respectively denote an optionally substituted branched alkyl group.

In another aspect, the present invention provides a polymerizable composition for producing an optical member comprising;

a polymerizable monomer composition comprising at least one polymerizable monomer denoted by a formula (1b);

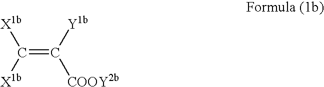

wherein X^{1b} is hydrogen (H) or deuterium (D) and two X^{1b}s may be same or different each other; Y^{1b} is H, D, fluorine (F) CH₃, CD₃ or CF₃; and Y^{2b} is a substituted or non-substituted C₁₋₇ alkyl group provided that Y^{2b} is a fluorine-containing C₁₋₇ alkyl group substituted with 1 to 15 fluorine atoms when Y^{1b} is H, D, CH₃ or CD₃;

a polymerization initiator and

a compound, having a different refractive index from that of the polymerizable monomer composition, denoted by a formula (2b);

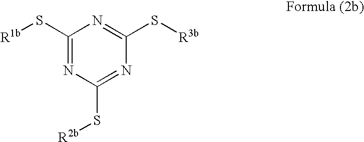

wherein R^{1b}, R^{2b} and R^{3b} respectively denote an optionally substituted alkyl group or an optionally substituted aryl group provided that all of R^{1b}, R^{2b} and R^{3b} aren't simultaneously optionally substituted aryl group.

As embodiments of the present invention, the polymerizable composition wherein the compound having a different refractive index from that of the polymerizable composition is selected form the group denoted by a formula (3b);

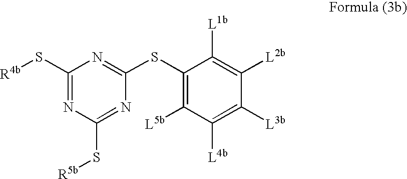

wherein R^{4b} and R^{5b} respectively denote an optionally substituted alkyl group, L^{1b}, L^{2a}, L^{3b}, L^{4b} and L^{5b} respectively denote a hydrogen atom, a halogen atom, an optionally substituted alkyl group, an optionally substituted alkoxy group or an optionally substituted alkylthio group provided that at least two of them denote respectively a halogen atom, an optionally substituted alkyl group, an optionally substituted alkoxy group or an optionally substituted alkylthio group; the polymerizable composition wherein the polymerizable monomer composition contains 5 to 100 weight % of the polymerizable monomer denoted by the formula (1b); the polymerizable composition wherein the polymerizable monomer denoted by the formula (1b) has at least one C-D bond; and the polymerizable composition wherein R^{1b}, R^{2b} and R^{3b} in the formula (2b) respectively denote an alkyl group substituted by at least one fluorine atom.

In another aspect, the present invention provides an optical member produced by polymerization of the polymerizable composition, so as to form a region having a graded refractive index; the optical member wherein the region having a graded refractive index along the direction from the center to the outside; and an optical fiber produced by drawing the optical member.

### BRIEF DESCRIPTION OF DRAWINGS

FIG. 1 is a schematic sectional view showing an exemplary configuration of a melt extrusion molding machine based on the inner sizing system available for the fabrication of the optical member in the present invention;

FIG. 2 is a schematic drawing of an exemplary configuration of a manufacturing line of the melt extrusion molding machine based on the outer die vacuum suction system available for the fabrication of the optical member in the present invention; and

FIG. 3 is a perspective view of a molding die available for the fabrication of the optical member in the present invention.

### DETAILED DESCRIPTION OF THE INVENTION

The embodiments of the present invention are described in detail bellow.

It is to be noted that the term of “optical material” is used for any materials for light guide elements such as optical fibers or light guides; lenses used for still cameras, camcorders, telescopes, glasses, plastic contact lenses or solar collectors; mirrors such as concave mirrors or polygon mirrors, and prisms such as pentaprism. It is also to be noted that examples of the optical members produced by polymerization of the compositions according to the present invention include light guide elements such as optical fibers or light guides; lenses used for still cameras, camcorders, telescopes, glasses, plastic contact lenses or solar collectors; mirrors such as concave mirrors or polygon mirrors, and prisms such as pentaprism. Among these, the optical members are desirably applied to light guide devices, lenses or mirrors, and more desirably applied to optical fibers, light guides or lenses.

1. Polymerizable Composition

At first, embodiments of the polymerizable composition according to the present invention are described in detail bellow.

1-1 First Embodiment of the Polymerizable Composition

The polymerizable composition according to the first embodiment of the present invention comprises a polymerizable monomer composition, which consists of one polymerizable monomer, or two or more polymerizable monomers, and at least one compound, occasionally referred to as “adjuster of refractive index” or “dopant”, having a different refractive index from that of the polymerizable monomer composition. The polymerizable composition of the first embodiment may further comprise a polymerization initiator and a chain transfer agent. According to the first embodiment, at least one compound selected from the compounds having a triazine skeleton are used as a dopant, thereby improving the optical properties of the optical members produced by polymerization of the composition comprising such a dopant. The polymerizable composition of the first embodiment may be used in producing GI type optical members.

Various materials used for the first embodiments are described bellow.

1-1-1 Polymerizable Monomer Composition

According to the first embodiment, the polymerizable monomer composition desirably comprises at least one selected from the group consisting of esters of propenoic acid and derivatives thereof in major proportion. Embodiments of esters of propenoic acids and derivatives thereof include acrylates and methacrylates, both of them are referred to as “(meth)acrylates” hereinafter. The term of “comprise a monomer in major proportion” is used for not only the embodiment consisting of the monomer, but also embodiments further comprising at least one polymerizable monomer other than the monomer so far as not lowering optical properties. The polymerizable monomer composition may contain at least one selected from the group consisting of (meth)acrylates and at least one selected from the group polymerizable monomers other than (meth)acrylates such as styrene or maleimide, so as to form any copolymers. When deuterated (meth)acrylates, in which at least a part of hydrogens are replaced with deuteriums, are used, optical members having low transmission loss can be produced, and thus deuterated (meth)acrylates are desirable. Using fluorinated (meth)acrylates may easily result in much difference of refractive index between the obtained optical fibers and copolymers of non-fluorinated monomers, and in consequence, may easily create graded refractive index structures. Thus, fluorinated (meth)acrylates are desirable.

Here lists examples of usable (meth)acrylates in the first embodiment, however, the examples are not limited to these.

(a) non-fluorine-containing (meth)acrylates such as methyl methacrylate, ethyl methacrylate, isopropyl methacrylate, t-butyl methacrylate, benzyl methacrylate, phenyl methacrylate, cyclohexyl methacrylate, diphenylmethyl methacrylate, tricyclo[5.2.1.0^{2,6}]decanyl methacrylate, adamantyl methacrylate, isobornyl methacrylate, methyl acrylate, ethyl acrylate, t-butyl acrylate or phenyl acrylate;

(b) fluorine-containing (meth)acrylates such as 2,2,2-trifluoroethyl methacrylate, 2,2,3,3-tetrafluoropropyl methacrylate, 2,2,3,3,3,-pentafluoropropyl methacrylate, 1-trifluoromethyl-2,2,2-trifluoroethyl methacrylate, 2,2,3,3,4,4,5,5-octafluoropentyl methacrylate or 2,2,3,3,4,4-hexafluorobutyl methacrylate are exemplified.

Polymerizable monomers other than (meth)acrylates may be used. Here lists examples of usable polymerizable monomers other than (meth)acrylates in the first embodiment, however, the examples are not limited to these.

(c) styrene base compounds such as styrene, alpha-methyl styrene, chlorostyrene or bromostyrene;

(d) vinyl esters such as vinyl acetate, vinyl benzoate, vinyl phenylacetate or vinyl chloroacetate;

(e) maleimides such as N-n-butylmaleimide, N-t-butylmaleimide, N-isopropylmaleimide or N-cyclohexyl maleimide are exemplified.

According to the first embodiment, one compound, or two or more compounds, selected from the group consisting of (meth)acrylates may be used as a major component of the polymerizable monomer composition. The content of the compound, or the content of the two or more compounds, selected from the group consisting of (meth)acrylates is desirably not smaller than 50 wt %, more desirably not smaller than 60 wt %, and much more desirably 70 wt %, of the total polymerizable monomer composition, and most desirably, all monomers contained in the polymerizable monomer composition are selected from the group consisting of (meth)acrylates.

In order to lower transmission loss, fluorine-containing polymerizable monomers, in which at least a part of hydrogen atoms in C—H bonds are replaced with fluorine atoms, having at least a C—F bond, are desirably used. In particular, any compounds selected from the group consisting of the above-mentioned fluorine-containing (meth)acrylates, or any mixtures of at least one selected from the group consisting of the above-mentioned fluorine-containing (meth)acrylates and at least one selected from the group consisting of non-fluorine-containing (meth)acrylates are desirably used.

In order to further lower transmission loss, deuterated compounds of the monomers exemplified above may be used.

1-1-2 Polymerization Initiator

Some polymerizable compositions of the first embodiment may be cured by an electron irradiation or the like without a polymerization initiator, however, in the viewpoint of controlling refractive index distribution or polymerization, the polymerizable composition of the first embodiment desirably comprises a polymerization initiator. The polymerization initiator may be selected from known polymerizable initiators depending on various factors such as polymerizable monomers contained in the composition or polymerization process. The examples of the polymerization initiator include peroxides such as benzoyl peroxide (BPO), t-butylperoxy-2-ethylhexanate (PBO), di-t-butylperoxide (PBD), t-butylperoxyisopropylcarbonate (PBI) or n-butyl-4,4-bis(t-butylperoxy)valerate (PHV); and azo compounds such as 2,2′-azobisisobuthylonitrile, 2,2′-azobis(2-methylbuthylonitrile), 1,1′-azobis(cyclohexane-1-carbonitrile), 2,2′-azobis(2-methylpropane), 2,2′-azobis(2-methylbutane), 2,2′-azobis(2-methylpentane), 2,2′-azobis(2,3-dimethylbutane), 2,2′-azobis(2-methylhexane), 2,2′-azobis(2,4-dimethylpentane), 2,2′-azobis(2,3,3-trimethylbutane), 2,2′-azobis(2,4,4-trimethylpentane), 3,3′-azobis(3-methylpentane), 3,3′-azobis(3-methylhexane), 3,3′-azobis(3,4-dimethylpentane), 3,3′-azobis(3-ethylpentane), dimethyl-2,2′-azobis(2-methylpropionate), diethyl-2,2′-azobis(2-methylpropionate) or di-t-butyl-2,2′-azobis(2-methylpropionate).

Two or more polymerization initiators may be used in combination.

1-1-3 Chain Transfer Agent

The composition according to the first embodiment desirably contains a chain transfer agent. The chain transfer agent may mainly be used for adjusting molecular weight of the obtained polymer. The chain transfer agent can be properly selected in consideration of the monomer to be employed. The chain transfer constants of the chain transfer agents for various monomers can be referred to publications such as “Polymer Handbook 3^{rd} edition” edited by J. BRANDRUP and E. H. IMMERGUT, published by JOHN WILEY&SON. The chain transfer constants can be also obtained by experimental tests according to methods disclosed in “Kohbunshi gousei no jikkenhou (Experimental methods for polymer synthesis)” written by Takayuki Ohtsu and Masaetsu Kinoshita, published by Kagaku-Dojin Publishing Company, INC (1972).

When methyl methacrylate is used as a polymerizable monomer, at least one selected from the group consisting of alkylmercaptans (n-butylmercaptan, n-pentylmercaptan, n-octylmercaptan, n-laurylmercaptan, t-dodecylmercaptan, etc.) and thiophenols (thiophenol, m-bromothiophenol, p-bromothiophenol, m-toluenethiol, p-toluenethiol, etc.) is desirably used as a chian transfer agent. Among these, alkyl mercaptans such as n-octylmercaptan, n-laurylmercaptan or t-dodecylmercapton are preferred. It is also possible to use the chain transfer agents in which at least a part of hydrogen atoms of C—H bonds are replaced with deuterium atoms. Two or more chain transfer agents may be used in combination.

1-1-4 Dopant: Adjuster of Refractive Index

The polymerizable composition according to the first embodiment contains a compound having a different refractive index from that of the polymerizable monomer composition. The dopant is also referred to as adjuster of refractive index, and a compound having a property that increases the refractive index of a composition containing it as compared with a composition not containing it. The difference in refractive index between the composition containing the dopant and the composition not containing the dopant is desirably not smaller than 0.001.

According to the first embodiment, at least one thio compound having a triazine skeltone selected from the group denoted by a formula (1a) or (2a) is used as a dopant. Using such a thio compound as a dopant contributes to facilitation of controlling refractive index and to lowering transmission loss of optical members. Especially, the thio compounds are suitable for creating graded refractive index structures through interfacial gel polymerization process hereinafter described in detail.

First, a formula (1a) will be described in detail.

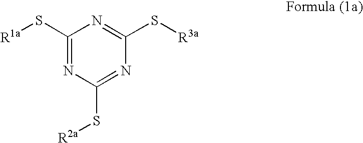

In the formula (1a), R^{1a}, R^{2a} and R^{3a} respectively denote an optionally substituted alkyl group. The carbon member of the alkyl group denoted by R^{1a}, R^{2a} or R^{3a} is desirably 1 to 24, more desirably 1 to 10 and much more desirably 1 to 6. The alkyl group may be linear or branched. Among the branched alkyl groups, the alkyl groups which are branched at the side closer to the position of S atom are preferred. Examples of R^{1a}, R^{2a} and R^{3a} include methyl, ethyl, propyl, butyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl and octylcyclohexyl. It is to be noted that the alkyl group denoted by R^{1a}, R^{2a} or R^{3a} means an alkyl group having no polymerizable group. When R^{1a}, R^{2a} or R^{3a} would be a compound having a polymerizable group such as compounds disclosed in JPA No. 1990-268170 or JPA No. 2002-255945, it would be difficult to control refractive index due to copolymerization of such a polymerizable group and an ethylene base polymerizable monomer.

R^{1a}, R^{2a} and R^{3a} may have at least one substituent group, except for any polymerizable groups. Preferred example of the substituent group include halogen atoms such as fluorine, chlorine and bromine; substituted or non-substituted, linear or branched alkyl groups, desirably C₁₋₂₄, more desirably C₁₋₁₀ alkyl groups, such as methyl, ethyl, propyl, butyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl or octylcyclohexyl; substituted or non-substituted, monocyclic or polycyclic aryl groups, desirably C₆₋₂₄ aryl groups, such as phenyl, 4-methylphenyl, 3-cyanophenyl 2-chlorophenyl or 2-naphtyl; substituted or non-substituted, monocyclic or polycyclic heterocyclic groups, desirably C₂₋₂₄ heterocyclic groups, such as 4-pyridyl, 2-pyridyl, 2-pyrimidyl, 2-imidazolyl or 2-thiazolyl; alkoxy groups, desirably C₁₋₂₄ alkoxy groups, such as methoxy, ethoxy, butoxy, octyloxy, methoxy ethoxy or methoxy penta(ethyloxy); alkylthio groups, desirably C₁₋₂₄ alkylthio groups, such as methylthio or ethylthio; acyloxy groups, desirably C₁₋₂₄ acyloxy groups, such as acetyloxy or benzoyloxy; alkoxycarbonyl groups, desirably C₂₋₂₄ alkoxycarbonyl groups, such as methoxycarbonyl or ethoxycarbonyl; and cyano.

A part of or all of hydrogen atoms included in R^{1a} to R^{3a} may be replaced with fluorine atoms. Examples of fluorine-containing R^{1a} to R^{3a} include 2,2,2-trifluoroethyl, 1-trifluoromethyl-2,2,2-trifluoroethyl, and 2,2,3,3,4,4,5,5-octafluoropentyl.

A part of or all of hydrogen atoms included in R^{1a} to R^{3a} may be also replaced with deuterium atoms.

Next, a formula (2a) will be described in detail.

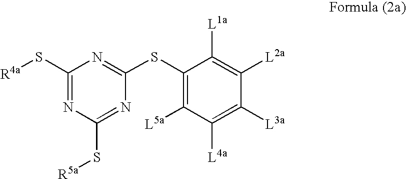

In the formula (2a), R^{4a} and R^{5a} respectively denote an optionally substituted alkyl group. The alkyl groups may have at least one substituent group, except for any polymerizable groups. The carbon number of the alkyl group is desirably t to 24, more desirably 1 to 10 and much more desirably 1 to 6. The alkyl group may have a linear chain structure or a branched chain structure. Examples of the alkyl group include methyl, ethyl, propyl, butyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl or octylcyclohexyl. It is to be noted that the alkyl group denoted by R^{4a} or R^{5a} means an alkyl group having no polymerizable group. And the preferred embodiment of the branched alkyl group is identical to that of R^{1a}, R^{2a} or R^{3a}.

R^{4a} or R^{5a} may have at least one substituent group, except for any polymerizable groups. Preferred examples of the substituent group are identical to the above exemplified examples for R^{1a} to R^{3a}. A part of or all of hydrogen atoms included in R^{4a} or R^{5a} may be replaced with fluorine atoms. A part of or all of hydrogen atoms included in R^{4a} or R^{5a} may be also replaced with deuterium atoms.

In the formula (2a), L^{1a}, L^{2a}, L^{3a}, L^{4a} and L^{5a} respectively denote a hydrogen atom, a halogen atom, an optionally substituted alkyl group, an optionally substituted alkoxy group or an optionally substituted alkylthio group provided that at least two of L^{1a}, L^{2a}, L^{3a}, L^{4a} and L^{5a} denote a halogen atom, an optionally substituted alkyl group, an optionally substituted alkoxy group or an optionally substituted alkylthio group. As mentioned above, when plastic optical members are used with a light source emitting near-IR light such as 850 nm, an absorption attributed to low overtone of stretching vibration of aromatic C—H bonds is a factor responsible for increasing transmission loss. In the compounds denoted by the formula, at least two hydrogen atoms among five hydrogen atoms on the benzene ring are replaced with the substituent groups, and therefore, using the compound denoted by the formula (2a) can contribute to reducing transmission loss.

The alkyl group denoted by L^{1a}, L^{2a}, L^{3a}, L^{4a} or L^{5a} may be linear or branched and the carbon number of the alkyl group is desirably from 1 to 24, more desirably from 1 to 10 and much more desirably from 1 to 6. Examples of the alkyl group include methyl, ethyl, propyl, butyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl and octylcyclohexyl.

The carbon number of the alkoxy group denoted by L^{1a}, L^{2a}, L^{3a}, L^{4a} or L^{5a} is desirably from 1 to 24, more deisirably fro 1 to 10 and much more desirably from 1 to 6. Examples of the alkoxy group include methoxy, ethoxy, isopropyloxy and butoxy.

The carbon number of the alkylthio group denoted by L^{1a}, L^{2a}, L^{3a}, L^{4a} or L^{5a} is desirably from 1 to 24, more desirably from 1 to 10 and much more desirably from 1 to 6. Examples of the alkylthio group include methylthio, ethylthio and isopropylthio.

Examples of halogen atom denoted by L^{1a}, L^{2a}, L^{3a}, L^{4a} or L^{5a} include fluorine, chlorine, bromine and iodine, and in the viewpoint of weather resistance, fluorine, chlorine or bromine is desirable.

The alkyl group, alkoxy group or alkylthio group denoted by L^{1a}, L^{2a}, L^{3a}, L^{4a} or L^{5a} may have at least one substituent group, except for any polymerizable groups. Preferred examples of the substituent group are identical to the above exemplified examples for R^{1a} to R^{3a}. A part of or all of hydrogen atoms included in L^{1a}, L^{2a}, L^{3a}, L^{4a} or L^{5a} may be replaced with fluorine atoms. A part of or all of hydrogen atoms included in L^{1a}, L^{2a}, L^{3a}, L^{4a} or L^{5a} may be also replaced with deuterium atoms.

Next, a formula (3a), which is in the scope of the formula (1a), will be described in detail.

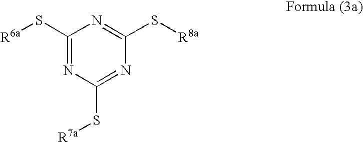

In the formula (3a), R^{6a}, R^{7a} and R^{8a} respectively denote an optionally substituted branched alkyl group, except an alkyl group substituted by any polymerizable group. Examples of the branched alkyl group include isopropyl, isobutyl, t-butyl, 2-ethylhexyl and t-octyl. Among the branched alkyl groups, the alkyl groups which are branched at the side closer to the position of S atom are preferred. The branched alkyl group may have at least one substituent group, and examples of the substituent group are identical to the above exemplified examples for R^{1a} to R^{3a}. A part of or all of hydrogen atoms included in R^{6a}, R^{7a} or R^{8a} (when R^{6a}, R^{7a} or R^{8a} has a substituent group, hydrogen atoms in the substituent group are also included) may be replaced with fluorine atoms. A part of or all of hydrogen atoms included in R^{6a}, R^{7a} or R^{8a} may be also replaced with deuterium atoms.

Examples of the thio compounds denoted by the formula (1a) or (2b) are exemplified bellow, but not limited to these.

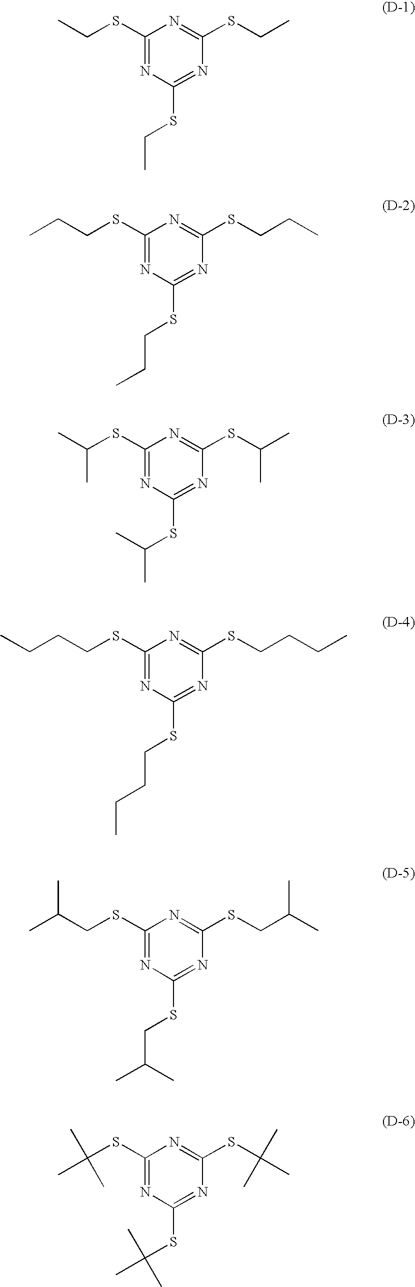

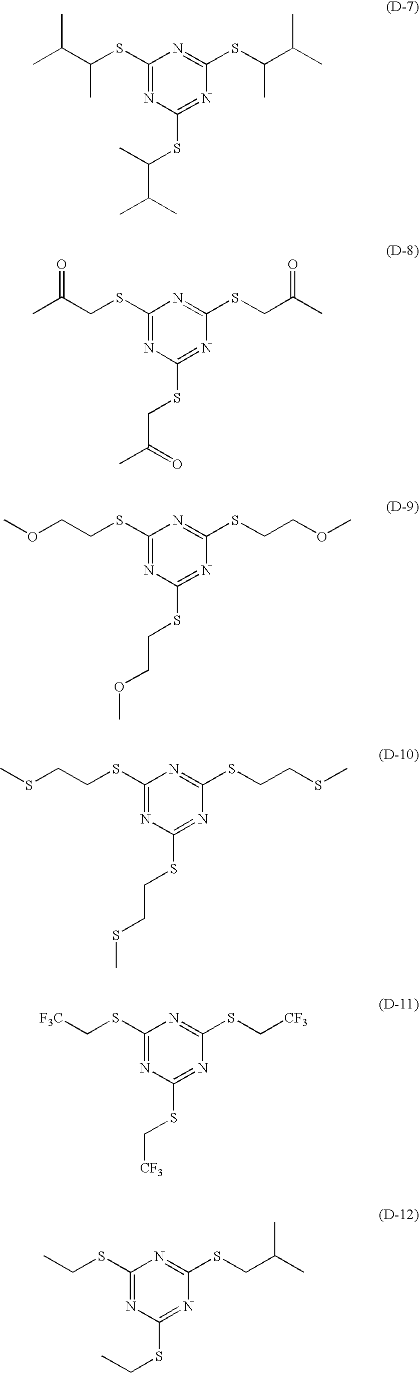

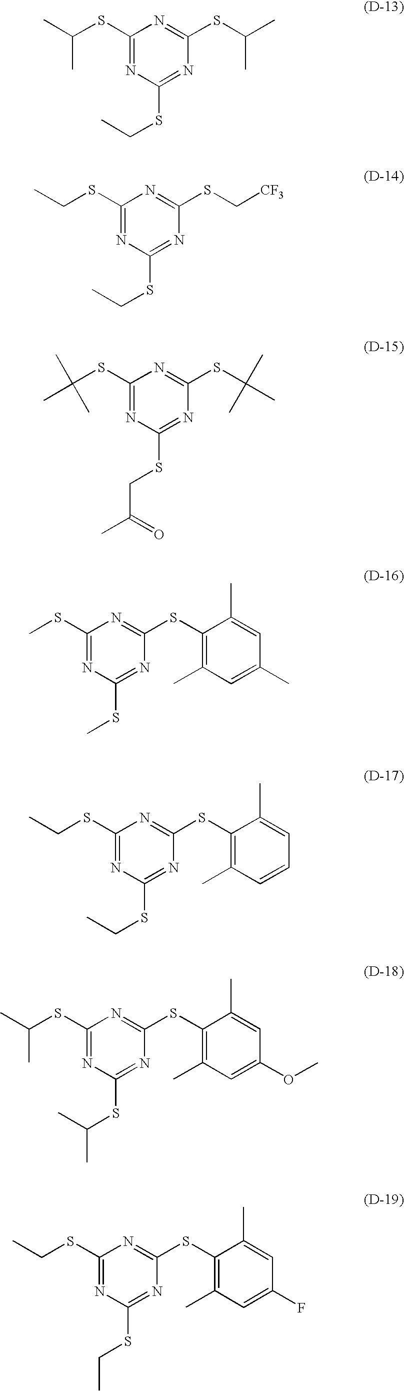

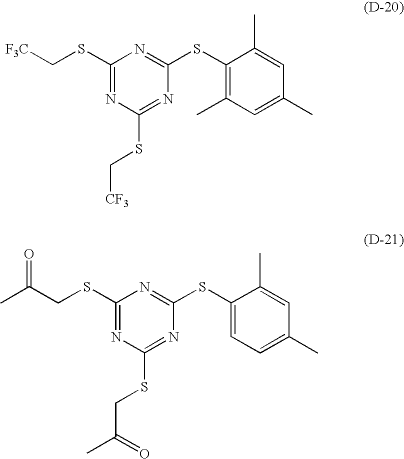

The compounds denoted by the formula (2a) or (3a) may be synthesized respectively by the following process.
Synthetic Method of Compounds Denoted by the Formula (2a) 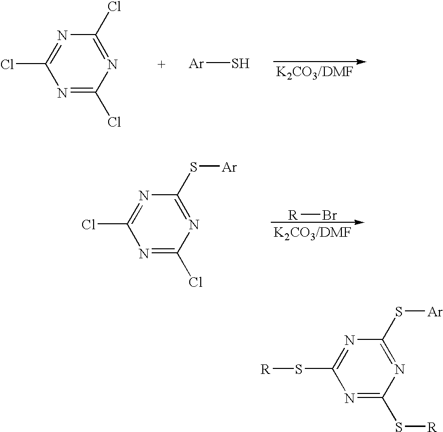
Synthetic Method of Compounds Denoted by the Formula (3a)

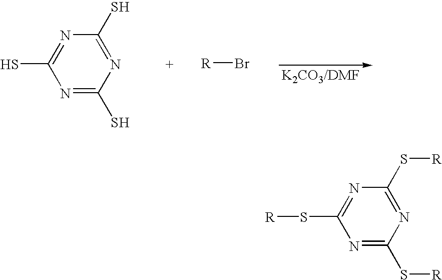

The thio compounds according to the first embodiment can be produced by reaction of thiocyanuric acids with halides or reaction of cyanuric acid chlorides with sulfides in the presence of base. The total molar quantity of the halide or the sulfide used in such reaction is desirably from 3 to 7.5 times, and more desirably from 3 to 4.5 times, as large as the molar quantity of the thiocyanuric acid or the cyanuric acid chloride.

Examples of the base include metal hydroxides such as sodium hydroxide or potassium hydroxide; metal carbonates such as potassium carbonate or sodium carbonate; tertiary amines such as triethylamine, trimethylamine or N,N-dimethylaniline; and metal alcoholates such as sodium ethanolate or potassium tert-butylate. The molar quantity of the base used in such reaction is desirably from 2 to 5 times, and more desirably from 2 to 3 times, as large as the molar quantity of the halide.

Aprotic polar solvents are desirably used as a reaction solvent. Examples of the aprotic polar solvents include dimethyl sulfoxide, dimethyl form amide, dimethyl acetamide and N-methyl-2-pyroridone.

The reaction temperature is desirably within the range from room temperature to 200° C. and more desirably within the range from room temperature to 160° C.

When triazine derivatives denoted by the formula (2a) are produced, it is desired from the viewpoint of produce yields that thiophenol derivatives as same or 1.2 times much as cyanuric acid chlorides by mole are first added to the cyanuric acid chlorides to give mono-substituted bodies, and subsequently, alkyl thiol reagents are introduced in such mono-substituted bodies.

The above mentioned process is one example of processes which can give the thio compounds having a triazine skeleton, and the present invention is not limited to the process.

According to the first embodiment, two or more compounds may be used as a dopant.

An optical member having a graded refractive index can be prepared by grading the concentration of the dopant while polymerization of the polymerizable composition of the first embodiment. One usable process for grading the dopant concentration is an interfacial gel polymerization process described later.

Preferable ranges of the amount of the components respectively may properly be determined in consideration of species to be employed, where the additional amount of the polymerization initiator is desirably within a range from 0.005 to 0.5 wt % and more desirably within a range from 0.010 to 0.50 wt %, with respect to the weight of the polymerizable monomer composition; and the additional amount of the chain transfer agent is desirably within a range from 0.10 to 0.40 wt %, and more desirably within a range from 0.15 to 0.30 wt %, with respect to the weight of the polymerizable monomer composition. The additional amount of the dopat is desirably in a range from 1 to 30 wt %, and more desirably in a range from 1 to 25 wt %, with respect to the weight of the polymerizable monomer composition.

Another possible strategy relates to addition of other additives to the polymerizable composition to an extent not degrading the light transmission property. For example, an additive can be added in order to improve the weatherability or durability. It is also allowable to add an emission inductive material for amplifying light signal for the purpose of improving the light transmission property. Since even attenuated light signal can be amplified by addition of such compound to thereby elongate the length of transmission, the compound is typically applicable to produce a fiber amplifier at a part of light transmission link.

When heat and/or light is irradiated to the polymerizable composition, radicals and the like are generated from the initiator, thereby inducing the polymerization of the polymerizable monomer. Since the polymerizable composition according to the first embodiment contains the dopant, the refractive-index-distributed structure can readily be obtained by controlling the proceeding direction of the polymerization, typically by the interfacial gel polymerization process described later, so as to create a concentration gradient of the dopant. When the polymerizable composition comprising a chain transfer agent is used, the molecular weight of the polymer can be adjusted by the chain transfer agent so as to be suitable in mechanical properties for drawing. Therefore, using such composition can also contribute to improvement in productivity when an optical fiber is prepared by drawing the preform produced by polymerization of the composition.

1-2 Second Embodiment of the Polymerizable Composition

The polymerizable composition according to the second embodiment may be used for producing optical member for 850 nm light source wavelength. The polymerizable composition according to the second embodiment comprises a polymerizable monomer composition, which consists of one polymerizable monomer, or two or more polymerizable monomers, a polymerization initiator capable initiating polymerization of the polymerizable monomer composition, a compound having a different refractive index from that of the polymerizable monomer composition (hereinafter referred to as “adjuster of refractive index” or “dopant”). According to the present invention, a compound selected from a particular group is used as a dopant, to thereby reduce transmission loss at 850 nm due to itself. Further, the compound selected from triazine derivatives which are improved in compatibility with fluorine-containing matrix, specifically fluorine-containing methyl methacrylate, is used as a dopant, to thereby reduce the transmission loss of an optical member formed of the combination of the dopant and the matrix, and to thereby improve the transmitting capacity of the optical member formed of the combination. The polymerizable composition of the second embodiment may be used for producing optical members, especially graded refractive index optical members.

Various materials used for the second embodiments are described bellow.

1-2-1 Polymerizable Monomer Composition

According to the second embodiment, the polymerizable monomer composition desirably comprises at least one selected from the group consisting of esters of propenoic acid and derivatives thereof in major proportion. Embodiments of esters of propenoic acids and derivatives thereof include acrylates and methacrylates, both of them are referred to as “(meth)acrylates” hereinafter. The term of “comprise a monomer in major proportion” is used for not only the embodiment consisting of the monomer, but also embodiments further comprising at least one polymerizable monomer other than the monomer so far as not lowering optical properties. The polymerizable monomer composition may contain at least one selected from the group consisting of (meth)acrylates and at least one selected from the group polymerizable monomers other than (meth)acrylates such as styrene or maleimide, so as to form any copolymers.

According to the second embodiment, especially in the viewpoint of reduction in transmission loss and hygroscopicity, the polymerizable monomer composition desirably comprises at least one selected from fluorine-containing (meth)acrylates, hereinafter referred to as “polymerizable monomer (A)”.

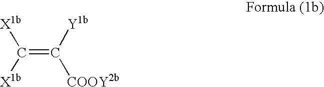

wherein X^{1b} is hydrogen (H) or deuterium (D) and two X^{1b}s may be same or different each other; Y^{1b} is H, D, fluorine (F) CH₃, CD₃ or CF₃; and Y^{2b} is a substituted or non-substituted C₁₋₇ alkyl group provided that Y^{2b} is a fluorine-containing C₁₋₇ alkyl group substituted with 1 to 15 fluorine atoms when Y^{1b} is H, D, CH₃ or CD₃.

The polymerizable monomer (A) may be selected from the group consisting of (meth)acrylate derivatives, which have a fluorine-containing C₁₋₇ alkyl group substituted with 1 to 15 fluorine atoms at a side chain (Y^{2b}), alpha-fluoro acrylate derivatives and alpha-trifluoromethyl methacrylate derivatives. Examples of the polymerizable monomer (A) include (meth)acrylate derivatives such as monofluoromethyl methacrylate, difluoromethyl methacrylate, trifluoroethyl methacrylate, 1H,1H-pentafluoropropyl methacrylate, 1H,1H,3H-tetrafluoropropyl methacrylate, 2H-hexafluoro-2-propyl methacrylate, heptafluoro-2-propyl methacrylate, perfluorohexylmethyl methacrylate or perfluoro-t-butyl methacrylate; alpha-fluoro acrylate derivatives such as methyl alpha-fluoroacrylate, ethyl alpha-fluoroacrylate, isopropyl alpha-fluoroacrylate, t-butyl alpha-fluoroacrylate, monofluoromethyl alpha-fluoroacrylate, difuoroethyl alpha-fluoroacrylate, trifluoroethyl alpha-fluoroacrylate, 1H,1H-pentafluoropropyl alpha-fluoroacrylate, 1H,1H,3H-tetrafluoropropyl alpha-fluoroacrylate, 2H-hexafluoro-2-propyl alpha-fluoroacrylate, heptafluoro-2-propyl alpha-fluoroacrylate, perfluorohexylmethyl alpha-fluoroacrylate or perfluoro-t-butyl alpha-fluoroacrylate; and alpha-trifluoro methacrylate derivatives such as methyl alpha-trifluoromethylacrylate, ethyl alpha-trifluoromethylacrylate, isopropyl alpha-trifluoromethylacrylate, t-butyl alpha-trifluoromethylacrylate, monofluoromethyl alpha-trifluoromethylacrylate, difluoromethyl alpha-trifluoromethylacrylate, trifluoroethyl alpha-trifluoromethylacrylate, 1H,1H-pentafluoropropyl alpha-trifluoromethylacrylate, 1H,1H,3H-tetrafluoropropyl alpha-trifluoromethylacrylate, 2H-hexafluoro-2-propyl alpha-trifluoromethylacrylate, heptafluoro-2-propyl alpha-trifluoromethylacrylate, perfluorohexylmethyl alpha-trifluoromethylacrylate or perfluoro-t-butyl alpha-trifluoromethylacrylate. Among these, trifluoroethyl methacrylate, 2H-hexafluoro-2-propyl methacrylate, heptafluoro-2-propyl methacrylate, perfluorohexylmethyl methacrylate, perfluoro-t-butyl methacrylate, 1H,1H,3H-tetrafluoropropyl methacrylate, methyl alpha-fluoroacrylate, isopropyl alpha-fluoroacrylate, t-butyl alpha-fluoroacrylate, trifluoroethyl alpha-fluoroacrylate, 2H-hexafluoro-2-propyl alpha-fluoroacrylate, methyl alpha-trifluromethylacrylate, isopropyl alpha-trifluoromethylacrylate, t-butyl alpha-trifluoromethylacrylate, trifluoroethyl alpha-trifluoromethylacrylate and 2H-hexafluoro-2-propyl alpha-trifluoromethylacrylate are preferred; and trifluoroethyl methacrylate, 2H-hexafluoro-2-propyl methacrylate, perfluoro-t-butyl methacrylate, methyl alpha-fluoroacrylate, t-butyl alpha-fluoroacrylate, trifluoroethyl alpha-fluoroacrylate, 2H-hexafluoro-2-propyl alpha-fluoroacrylate, methyl alpha-trifluoromethylacrylate, t-butyl alpha-trifluoromethylacrylate, trifluoroethyl alpha-trifluoromethylacrylate and 2H-hexafluoro-2-propyl alpha-trifluoromethylacrylate are more preferred.

From the viewpoint of the heat resistance, the optical properties, the plastic behavior or the like, the polymerizable monomer composition desirably comprises the polymerizable monomer (A) and at least one selected from the group denoted by a formula (4b), hereinafter referred to as “polymerizable monomer (B)”.

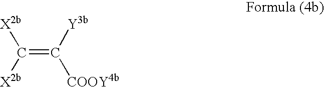

In the formula (4b), X^{2b} is a hydrogen atom (H) or a deuterium atom (D) and two X^{2b}s may be identical or different each other; Y^{3b} H, D, a fluorine atom (F), CH₃, CD₃ or CF₃; and Y^{4b} is a C₇₋₂₀ alicyclic hydrocarbon group.

The polymerizable monomer (B) may be selected from the group consisting of (meth)acrylates derivatives, alpha-fluoroacrylate derivatives and alpha-trifluoromethylacrylate derivatives, which have a C₇₋₂₀ alicyclic hydrocarbon group (Y^{4b}) Examples of the polymerizable monomer (B) include (meth)acrylate derivatives such as bicyclo-2,2,1-heptyl-2(meth)acrylate, 1-adamantyl (meth)acrylate, 2-adamantyl(meth)acrylate, 3-methyl-1-adamantyl(meth)acrylate, 3,5-dimethyl-1-adamantyl (meth)acrylate, 3-ethyladamantyl(meth)acrylate, 3-methyl-5-ethyl-1-adamantyl(meth)acrylate, 3,5,8-triethyl-1-adamantyl(meth)acrylate, 3,5-dimethyl-8-ethyl-1-adamantyl meth)acrylate, octahydro-4,7-menthanoindene-5-yl(meth)acrylate, octahydro-4,7-menthanoindene-5-ylmethyl(meth)acrylate, 1-menthyl(meth)acrylate, tricyclodecyl(meth)acrylate, 3-hydroxy-2,6,6,-trimethyl-bicyclo[3,1,1]heptyl (meth)acrylate, 3,7,7-trimethyl-4-hydroxy-bicyclo[4,1,0]heptyl(meth)acrylate, (nor)bornyl(meth)acrylate, isobornyl (meth)acrylate, phentyl(meth)acrylate or 2,2,5-trimethylcyclohexyl(meth)acrylate; alpha-fluoroacrylate derivatives such as (bicyclo-2,2-1-heptyl-2) alpha-fluoroacrylate, 3-methyl-1-adamantyl alpha-fluoroacrylate, 3,5-dimethyl-1-adamantyl alpha-fluoroacrylate, 1-menthyl alpha-fluoroacrylate, (nor)bornyl alpha-fluoroacrylate, isobornyl alpha-fluoroacrylate or phentyl alpha-fluoroacrylate; and alpha-trifluoromethylacrylate derivatives such as (bicyclo-2,2-1-heptyl-2) alpha-trifluoromethylacrylate, 3-methyl-1-adamantyl alpha-trifluoromethylacrylate, 3,5-dimethyl-1-adamantyl alpha-trifluoromethylacrylate, 1-menthyl alpha-trifluoromethylacrylate, (nor)bornyl alpha-trifluoromethylacrylate, isobornyl alpha-trifluoromethylacrylate or phentyl alpha-trifluoromethylacrylate. Among these, (nor)bornyl (meth)acrylate, isobornyl(meth)acrylate, phentyl methacrylate, 1-menthyl methacrylate, 3-methyl-1-adamantyl alpha-fluoroacrylate, 3,5-dimethyl-1-adamantyl alpha-fluoroacrylate, 1-menthyl alpha-fluoroacrylate, (nor)bornyl alpha-fluoroacrylate, isobornyl alpha-fluoroacrylate, 3-methyl-1-adamantyl alpha-trifluoromethylacrylate, 3,5-dimethyl-1-adamantyl alpha-trifluoromethylacrylate, 1-mentyl alpha-trifluoromethylacrylate, (nor)bornyl alpha-trifluoromethylacrylate, isobornyl alpha-trifluoromethylacrylate and phentyl alpha-trifluoromethylacrylate are preferred; and furthermore, (nor)bornyl methacrylate, isobornyl(meth)acrylate, 1-menthyl methacrylate, (nor)bornyl alpha-fluoroacrylate, isobornyl alpha-fluoroacrylate, (nor)bornyl alpha-trifluoromethylacrylate and isobornyl alpha-trifluoromethylacrylate are more preferred.

The amount of the polymerizable monomer (A) may be from 5 to 100 wt % with respect to the total amount of the polymerizable monomer composition. According to the second embodiment, the polymerizable monomer (A) is desirably used in major portion, and the amount of the monomer (A) is desirably from 15 to 99 wt %, more desirably from 15 to 95 wt %, and much more desirably from 20 to 95 wt % with respect to the total amount of the polymerizable monomer composition. The preferred examples of the other polymerizable monomer used in the second embodiment are selected from the polymerizable monomers (B). The amount of the polymerizable monomer (B) is desirably from 5 to 95 wt %, more desirably from 10 to 95 wt % and much more desirably from 15 to 90 wt % with respect to the total amount of the polymerizable monomer composition. The amount ratio of the polymerizable monomer (A) to the polymerizable monomer (B) is desirably from 4/1 to 1/3 and more desirably from 3/1 to 1/2.

From the viewpoint of compensation for brittleness or mechanical properties of the polymers, the polymerizable monomer (A) may be co-polymerized with at least one polymerizable monomer selected from the polymerizable monomers (B) and/or the other polymerizable monomers. For example, the polymerizable monomer (A) may be co-polymerized with at least one polymerizable monomer selected from the group consisting of methyl methacrylate, ethyl methacrylate, isopropyl methacrylate, t-butyl methacrylate, benzyl methacrylate, phenyl methacrylate, cyclohexyl methacrylate, methyl acrylate, ethyl acrylate, n-butyl acrylate, t-butyl acrylate and phenyl acrylate. Among copolymers obtained such co-polymerizations, copolymers of methyl methacrylate are preferred.

The amount of the polymerizable monomer other than the polymerizable monomer (A) or (B) is desirably from 5 to 50 wt %, more desirably from 5 to 45 wt % and much more desirably from 5 to 40 wt % with respect to the to the total amount of the polymerizable monomer composition.

The polymerizable monomer composition may comprise at least one polymerizable monomer other than (meth)acrylates. Examples of the other polymerizable monomers used in the second embodiment are shown bellow, however not limited to these.

Polymerizable monomers C: styrenes such as styrene, alpha-methyl styrene, chloro styrene or bromo styrene;

Polymerizable monomer D: vinyl esters such as vinyl acetate, vinyl benzoate, vinyl phenyl acetate or vinyl chloro acetate; and

Polymerizable monomers E: maleimides such as N-methyl maleimide, N-ethyl maleimide, N-n-butyl maleimide, N-t-butyl maleimide, N-isopropyl maleimide or N-cyclohexyl maleimide.

According to the second embodiment, (meth)acrylates may be used in a major portion, and the amount of the (meth)acrylates is desirably not smaller than 50 wt %, more desirably not smaller than 60 wt %, much more desirably not smaller than 70 wt % and most desirably 100 wt % with respect to the total amount of the polymerizable monomer composition.

In order to lower transmission loss at 850 nm, deuterated polymerizable monomers, having C-D bonds in which H atoms are substituted with D atoms, may be used.

1-2-2 Polymerization Initiator

The polymerizable composition of the second embodiment may contain a polymerization initiator capable initiating the polymerization of the polymerizable monomer composition. The polymerization initiator may be selected from known polymerizable initiators depending on various factors such as polymerizable monomers contained in the composition or polymerization process. The examples of the polymerization initiator include peroxides such as benzoyl peroxide (BPO), t-butylperoxy-2-ethylhexanate (PBO), di-t-butylperoxide (PBD), t-butylperoxyisopropylcarbonate (PBI) or n-butyl-4,4-bis(t-butylperoxy)valerate (PHV); and azo compounds such as 2,2′-azobisisobuthylonitrile, 2,2′-azobis(2-methylbuthylonitrile), 1,1′-azobis(cyclohexane-1-carbonitrile), 2,2′-azobis(2-methylpropane), 2,2′-azobis(2-methylbutane), 2,2′-azobis(2-methylpentane), 2,2′-azobis(2,3-dimethylbutane), 2,2′-azobis(2-methylhexane), 2,2′-azobis(2,4-dimethylpentane), 2,2′-azobis(2,3,3-trimethylbutane), 2,2′-azobis(2,4,4-trimethylpentane), 3,3′-azobis(3-methylpentane), 3,3′-azobis(3-methylhexane), 3,3′-azobis(3,4-dimethylpentane), 3,3′-azobis(3-ethylpentane), dimethyl-2,2′-azobis(2-methylpropionate), diethyl-2,2′-azobis(2-methylpropionate) or di-t-butyl-2,2′-azobis(2-methylpropionate). Two or more polymerization initiators may be used in combination.

1-2-3 Chain Transfer Agent

The composition according to the second embodiment desirably contains a chain transfer agent. The chain transfer agent may mainly be used for adjusting molecular weight of the obtained polymer. The kind of or the amount of the chain transfer agent can be properly decided depending on the kind or the amount of the monomer to be employed. The chain transfer constants of the chain transfer agents for various monomers can be referred to publications such as “Polymer Handbook 3^{rd} edition” edited by J. BRANDRUP and E. H. IMMERGUT, published by JOHN WILEY&SON. The chain transfer constants can be also obtained by experimental tests according to methods disclosed in “Kohbunshi gousei no jikkenhou (Experimental methods for polymer synthesis)” written by Takayuki Ohtsu and Masaetsu Kinoshita, published by Kagaku-Dojin Publishing Company, INC (1972).

When methyl methacrylate derivatives are used as a polymerizable monomer, at least one selected from the group consisting of alkylmercaptans (n-butylmercaptan, n-pentylmercaptan, n-octylmercaptan, n-laurylmercaptan, t-dodecylmercaptan, etc.) and thiophenols (thiophenol, m-bromothiophenol, p-bromothiophenol, m-toluenethiol, p-toluenethiol, etc.) is desirably used as a chain transfer agent. Among these, alkyl mercaptans such as n-octylmercaptan, n-laurylmercaptan or t-dodecylmercapton are preferred. It is also possible to use the chain transfer agents in which at least a part of hydrogen atoms of C—H bonds are replaced with deuterium atoms. Two or more chain transfer agents may be used in combination.

1-2-4 Dopant: Adjuster of Refractive Index

The polymerizable composition according to the second embodiment contains a compound having a different refractive index from that of the polymerizable monomer composition. The dopant is also referred to as adjuster of refractive index, and a compound having a property that increases the refractive index of a composition containing it as compared with a composition not containing it. The difference in refractive index between the composition containing the dopant and the composition not containing the dopant is desirably not smaller than 0.001.

According to the second embodiment, at least one compound having a triazine skeleton selected from the group denoted by a formula (2b) is used as a dopant. Using such a compound having a triazine skeleton may facilitate adjusting refractive indexes of the plastic optical members and lower transmission loss of the plastic optical members. The thio compounds denoted by the formula (2b) are suitable for creating graded refractive index structures through interfacial gel polymerization process hereinafter described in detail.

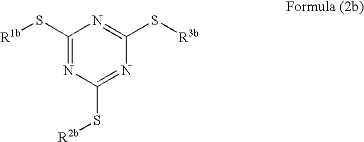

In the formula (2b), R^{1b}, R^{2b} and R^{3b} respectively denote an optionally substituted alkyl group or an optionally substituted aryl group provided that all of R^{1b}, R^{2b} and R^{3b} aren't simultaneously optionally substituted aryl groups.

The carbon number of the alkyl group denoted by R^{1b}, R^{2b} or R^{3b} is desirably from 1 to 24, more desirably from 1 to 10 and much more desirably from 1 to 6. The alkyl group may be linear or branched. Examples of the alkyl group include methyl, ethyl, propyl, butyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl and octylcyclohexyl. It is to be noted that the alkyl group denoted by R^{1b}, R^{2b} or R^{3b} means an alkyl group having no polymerizable group.

Examples of the aryl group denoted by R^{1b}, R^{2b} or R^{3b} include substituted or non-substituted phenyl.

R^{1b}, R^{2b} or R^{3b} may have at least one substituent group, except for any polymerizable groups. Preferred example of the substituent group include halogen atoms such as fluorine, chlorine or bromine; substituted or non-substituted, linear or branched alkyl groups, desirably C₁₋₂₄, more desirably C₁₋₁₀ alkyl groups, such as methyl, ethyl, propyl, butyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl or octylcyclohexyl; substituted or non-substituted, monocyclic or polycyclic aryl groups, desirably C₆₋₂₄ aryl groups, such as phenyl, 4-methylphenyl, 3-cyanophenyl 2-chlorophenyl or 2-naphtyl; substituted or non-substituted, monocyclic or polycyclic heterocyclic groups, desirably C₂₋₂₄ heterocyclic groups, such as 4-pyridyl, 2-pyridyl, 2-pyrimidyl, 2-imidazolyl or 2-thiazolyl; alkoxy groups, desirably C₁₋₂₄ alkoxy groups, such as methoxy, ethoxy, butoxy, octyloxy, methoxy ethoxy or methoxy penta(ethyloxy); alkylthio groups, desirably C₁₋₂₄ alkylthio groups, such as methylthio or ethylthio; acyloxy groups, desirably C₁₋₂₄ acyloxy groups, such as acetyloxy or benzoyloxy; alkoxycarbonyl groups, desirably C₂₋₂₄ alkoxycarbonyl groups, such as methoxycarbonyl or ethoxycarbonyl; and cyano.

A part of or all of hydrogen atoms included in R^{1b}, R^{2b} or R^{3b} may be substituted with fluorine atoms. Examples of the flourine-containing group include 2,2,2-trifluoroethyl, 1-trifluoromethyl-2,2,2-trifluoroethyl and 2,2,3,3,4,4,5,5-octafluoropentyl.

A formula (3b) shown bellow is within the scope of the formula (2b).

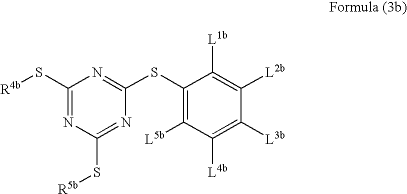

In the formula (3b), R^{4b} and R^{5b} respectively denote an optionally substituted branched or linear alkyl group, desirably C₁₋₂₄, more desirably C₁₋₁₀, and much more desirably C₁₋₆ alkyl group, such as methyl, ethyl, propyl, butyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl and octylcyclohexyl. It is to be noted that the alkyl group denoted by R^{4b} or R^{5b} means an alkyl group having no polymerizable group.

R^{4b} or R^{5b} may have at least one substituent group except for any polymerizable groups, and preferred examples of the substituent group include those exemplified above as preferred examples for R^{1b}, R^{2b} and R^{3b}. A part of or all of hydrogen atoms included in R^{4b} or R^{5b} may be replaced with fluorine atoms.

As above mentioned, the absorption attributed to overtone of aromatic C—H bonds stretching vibration is a factor responsible for increasing transmission loss at 850 nm. At least two of five hydrogen atoms on the benzene ring included in the compound denoted by the formula (3b) are replaced with substituent groups, and therefore, using such a compound contributes to lowering the transmission loss.

In the formula (3b), L^{1b}, L^{2b}, L^{3b}, L^{4b} and L^{5b} respectively denote a hydrogen atom, a halogen atom, an optionally substituted alkyl group except for any polymerizable groups, an optionally substituted alkoxy group or an optionally substituted alkylthio group provided that at least two of them denote respectively a halogen atom, an optionally substituted alkyl group, an optionally substituted alkoxy group or an optionally substituted alkylthio group. The alkyl group may be branched or linear. The alkyl group denoted by L^{1b}, L^{2b}, L^{3b}, L^{4b} or L^{5b} is desirably selected from C₁₋₂₄ alkyl groups, more desirably selected from C₁₋₁₀ alkyl groups and much more desirably selected from C₁₋₆ alkyl groups, such as methyl, ethyl, propyl, butyl, i-propyl, i-butyl, pentyl, hexyl; octyl, 2-ethylhexyl, t-octyl, decyl, dodecyl, tetradecyl, 2-hexyldecyl, hexadecyl, octadecyl, cyclohexylmethyl or octylcyclohexyl.

The alkoxy group denoted by L^{1b}, L^{2b}, L^{3b}, L^{4b} or L^{5b} is desirably selected from C₁₋₂₄ alkoxy groups, more desirably selected from C₁₋₁₀ alkoxy groups and much more desirably selected from C₁₋₆ alkoxy groups, such as methoxy, ethoxy, isopropyloxy or butoxy.

The alkylthio group denoted by L^{1b}, L^{2b}, L^{3b}, L^{4b} or L^{5b} is desirably selected from C₁₋₂₄ alkylthio groups, C₁₋₁₀ alkylthio groups and C₁₋₆ alkylthio groups, such as methylthio, ethylthio or isopropylthio.

The halogen atom denoted by L^{1b}, L^{2b}, L^{3b}, L^{4b} or L^{5b} is fluorine, chlorine, bromine or iodine, from the viewpoint of anti-weatherability, is desirably fluorine, chlorine or bromine.

The alkyl group, the alkoxy group or the alkylthio group respectively denoted by L^{1a}, L^{2a}, L^{3a}, L^{4a} or L^{5a} may have at least one substituent group, and preferred examples of the substituent group include those above exemplified as examples for R^{1b}, R^{2b} or R^{3a}. A part of or all of hydrogen atoms included in L^{1b}, L^{2b}, L^{3a}, L^{4a} or L⁵ may be replaced with fluorine atoms.

Specific examples of the thio compounds denoted by the formula (2b) or (3b) are shown bellow, however are not limited to these.

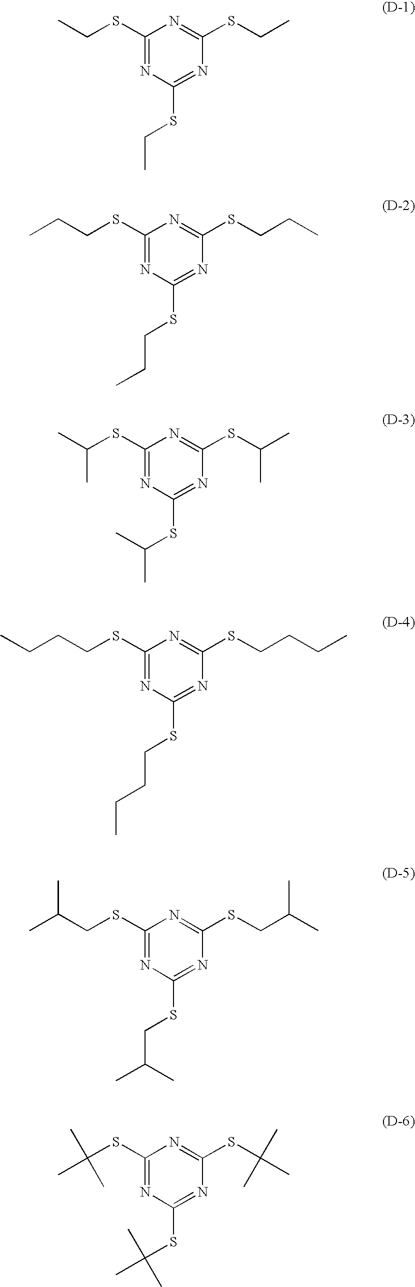

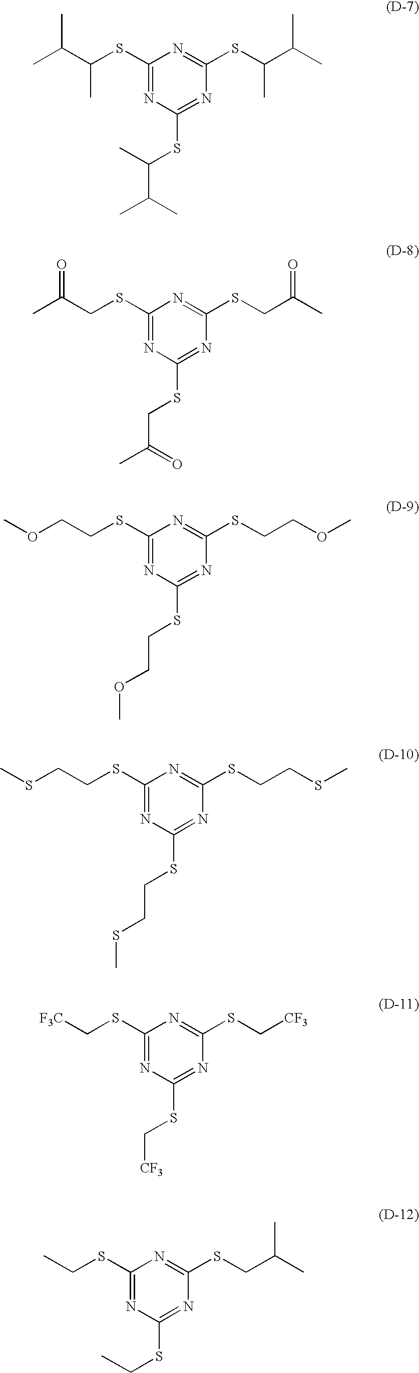

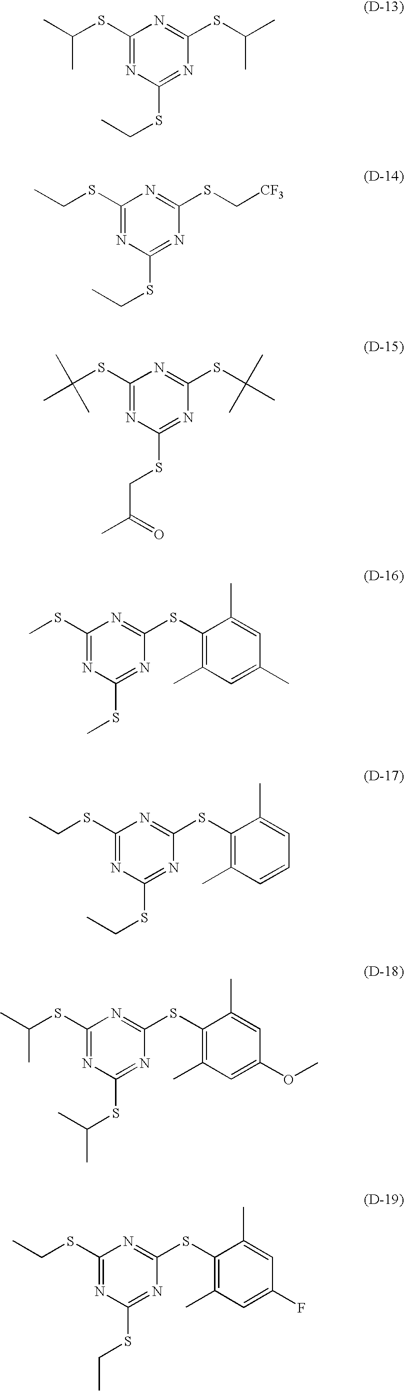

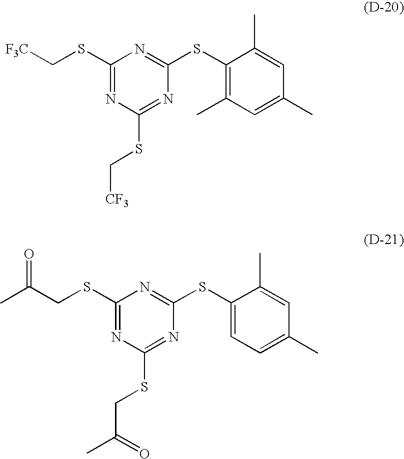

The thio compounds according to the second embodiment can be produced by reaction of thiocyanuric acids with halides or reaction of cyanuric acid chlorides with sulfides in the presence of base. The total molar quantity of the halide or the sulfide used in such reaction is desirably from 3 to 7.5 times, and more desirably from 3 to 4.5 times, as large as the molar quantity of the thiocyanuric acid or the cyanuric acid chloride.

Examples of the base include metal hydroxides such as sodium hydroxide or potassium hydroxide; metal carbonates such as potassium carbonate or sodium carbonate; tertiary amines such as triethylamine, trimethylamine or N,N-dimethylaniline; and metal alcoholates such as sodium ethanolate or potassium tert-butylate. The molar quantity of the base used in such reaction is desirably from 2 to 5 times, and more desirably from 2 to 3 times, as large as the molar quantity of the halide.

Aprotic polar solvents are desirably used as a reaction solvent. Examples of the aprotic polar solvents include dimethyl sulfoxide, dimethyl formamide, dimethyl acetamide and N-methyl-2-pyroridone.

The reaction temperature is desirably within the range from room temperature to 200° C. and more desirably within the range from room temperature to 160° C.

When triazine derivatives denoted by the formula (2b) are produced, it is desired from the viewpoint of produce yields that thiophenol derivatives as same or 1.2 times much as cyanuric acid chlorides by mole are first added to the cyanuric acid chlorides to give mono-substituted bodies, and subsequently, alkyl thiol reagents are introduced in such mono-substituted bodies.

The above mentioned process is one example of processes which can give the thio compounds having a triazine skeleton, and the present invention is not limited to the process.

According to the second embodiment, two or more compounds selected from the group denoted by the formula (2b) may be used as a dopant. Unless the effect of the second embodiment would be lowered, the other compounds may be used in the combination with the compounds denoted by the formula (2b).

An optical member having a graded refractive index can be prepared by grading the concentration of the dopant while polymerization of the polymerizable composition of the second embodiment. One usable process for grading the dopant concentration is an interfacial gel polymerization process described later.

Preferable ranges of the amount of the components respectively may properly be determined in consideration of species to be employed, where the additional amount of the polymerization initiator is desirably within a range from 0.005 to 0.5 wt % and more desirably within a range from 0.010 to 0.50 wt %, with respect to the weight of the polymerizable monomer composition; and the additional amount of the chain transfer agent is desirably within a range from 0.10 to 0.40 wt %, and more desirably within a range from 0.15 to 0.30 wt %, with respect to the weight of the polymerizable monomer composition. The additional amount of the dopant is desirably in a range from 1 to 30 wt %, and more desirably in a range from 1 to 25 wt %, with respect to the weight of the polymerizable monomer composition.

Another possible strategy relates to addition of other additives to the polymerizable composition to an extent not degrading the light transmission property. For example, an additive can be added in order to improve the weatherability or durability. It is also allowable to add an emission inductive material for amplifying light signal for the purpose of improving the light transmission property. Since even attenuated light signal can be amplified by addition of such compound to thereby elongate the length of transmission, the compound is typically applicable to produce a fiber amplifier at a part of light transmission link.

When heat and/or light is irradiated to the second polymerizable composition, radicals and the like are generated from the initiator, thereby inducing the polymerization of the polymerizable monomer. Since the polymerizable composition according to the second embodiment contains the dopant, the refractive-index-distributed structure can readily be obtained by controlling the proceeding direction of the polymerization, typically by the interfacial gel polymerization process described later, so as to create a concentration gradient of the dopant. According to the second embodiment, for preventing absorption attributed to the fourth overtone of C—H stretching vibration in a benzene ring from influencing 850 nm light of a light source, the dopant improved so that the absorption is significantly shifted to longer wavelengths is used, and therefore, transmission loss due to the dopant can be lowered. When the polymerizable composition comprising a chain transfer agent is used, the molecular weight of the polymer can be adjusted by the chain transfer agent so as to be suitable in mechanical properties for drawing. Therefore, using such composition can also contribute to improvement in productivity when an optical fiber is prepared by drawing the preform produced by polymerization of the composition.

2. Optical Member

Examples processes for producing optical members with the polymerizable composition of the first or second embodiment will be described in detail. The polymerizable composition of the first or second embodiment may be used for producing a core region of graded-refractive-index optical member comprising the core region and a clad region.

As examples of the processes for producing GI type optical member, a process (1) and a process (2) are described bellow.

Process (1) comprises a first step of producing a hollow structure (for example a cylinder) corresponding to the clad region by carrying out polymerization of a polymerizable composition; a second step of producing a preform which comprises regions respectively corresponding to the core region and the clad region by carrying out polymerization of a polymerizable composition of the first or the second embodiment in the hollow portion of the structure; and a third step of processing the obtained preform into various forms.

Process (2) comprises a first step of producing a hollow structure made of at least two concentric layers, one of which is corresponding to a clad region and another is an outer core layer, by carrying out polymerization of a polymerizable composition in the hollow portion of a hollow structure (for example a cylinder) corresponding to the clad region, which is formed of a fluorine polymer such as polyvinylidene fluoride, to form the outer core layer; a second step of producing a preform which comprises regions respectively corresponding to an inner core region, the outer core layer and clad region by carrying out polymerization of a polymerizable composition of the first or the second embodiment in the hollow portion of the structure made of at least two concentric layers, to form the inner core region; and a third step of processing the obtained preform into various forms.

The hollow structure made of at least two concentric layers may be prepared by one step for melt co-extrusion of a fluorine polymer for the clad region and a polymer for the outer core layer.

The polymerizable composition for producing the clad region in the process (1) or the polymerizable composition for producing the outer core layer used in the process (2) may comprise a polymerizable monomer composition, a polymerization initiator for initiating polymerization of the polymerizable monomer composition and a chain transfer agent.

The polymerizable composition for producing the core region used in the process (1) or the polymerizable composition for producing the inner core region used in the process (2) is a polymerizable composition of the first embodiment containing at least one compound selected from the group denoted by the formula (1a) or (2a) and at least one polymerizable monomer, desirably selected from (meth)acrylate derivatives, and if necessary a polymerization initiator for initiating polymerization of the monomer and a chain transfer agent. Or the polymerizable composition for producing the core region used in the process (1) or the polymerizable composition for producing the inner core region used in the process (2) is a polymerizable composition of the first embodiment containing at least one compound selected from the group denoted by the formula (2b) and at least one polymerizable monomer selected from the group denoted by the formula (1b), and if necessary a polymerization initiator for initiating polymerization of the monomer and a chain transfer agent. The thio compound selected from the group denoted by the formula (1a), (2a) or (2b), having a different refractive index from that of the polymerizable monomer composition, functions as a refractive index adjuster. According to the present invention, since the core region or the inner core region is prepared by polymerization of a polymerizable composition containing the thio compound selected from the group denoted by the formula (1a), (2a) or (2b), thereby to have a graded refractive index, the obtained plastic fiber is excellent in transmission loss and transmitting band. For using the polymerizable composition of the second embodiment, the composition contains the dopant which has no absorption at 850 nm and a fluorine-containing polymerizable monomer which can give hydrophobic matrix, and as a result, the obtained plastic fiber is excellent in transmission loss and moisture-resistance.

The major ingredient of the polymerizable monomer composition used in the first step is desirably same as that of the polymerizable monomer composition used in the second step. The ration and the minor ingredient thereof may be same or different. It is possible to improve transparency and adhesiveness of the clad/core interface or outer-core/inner-core interface by using same polymerizable monomers in major proportion for producing the clad and core regions or the outer core and inner core regions.

In the process (2), the outer core layer is formed between the core and clad regions, in order to improve the adhesiveness between the clad and core region even if they are formed of absolutely different materials each other. As a result, producing the outer core layer can contribute to widening the scope of choices for materials. The hollow structure corresponding to the clad region used in the process (2) is desirably formed of a fluorine polymer which is hydrophobic and has a low refractive index, and the examples of such a fluorine polymer include polyvinylidene fluoride. The hollow structure corresponding to the clad region can be prepared by a step of carrying out melt extrusion of a commercially available fluorine polymer to form a pipe having a desired diameter and a desired thickness. The hollow structure made of at least two concentric layers can be prepared by a step of carrying out a polymerization of a polymerizable composition in the hollow of the structure corresponding to the clad region, to thereby form an outer core layer. The hollow structure made of at least two concentric layers can be also prepared by a step of carrying out a melt co-extrusion of a fluorine polymer for the clad region and a polymer for the outer core layer.

Preferable ranges of the amount of the components contained in the polymerizable compositions respectively may properly be determined in consideration of species of the monomer to be employed, where the additional amount of the polymerization initiator is desirably in a range from 0.005 to 0.050 wt % of the polymerizable monomer composition, and more desirably in a range from 0.010 to 0.50 wt %, and the additional amount of the chain transfer agent is desirably in a range from 0.10 to 0.40 wt % of the monomer composition, and more desirably in a range from 0.15 to 0.30 wt %. The additional amount of the refractive index adjuster is desirably in a range from 1 to 30 wt % of the polymerizable monomer composition, and more desirably in a range from 1 to 25 wt %.

The polymers for the clad region and the core region (the term of “core region” is used hereinafter for a core region obtained by the process (1) and an inner core region obtained by the process (2)) have desirably the weight-average molecular weight within a range from 10,000 to 1,000,000, more desirably from 30,000 to 500,000 so as to be readily drawn. The molecular-weight distribution (MDW: a weight-average molecular weight/a number-average molecular weight) may affect drawing stability. If the MWD is too large, there are components having an extremely high molecular-weight, so that it is sometimes impossible to draw the preform because of the presence of such components. Accordingly, the MWD is desirably not greater than 4, and more desirably not grater than 3.

Another possible strategy relates to addition of other additives to the polymerizable composition for the clad region or the core region to an extent not degrading the light transmission property. For example, an additive can be added in order to improve the weatherability or durability. It is also allowable to add an emission inductive material for amplifying light signal for the purpose of improving the light transmission property. Since even attenuated light signal can be amplified by addition of such compound to thereby elongate the length of transmission, the compound is typically applicable to produce a fiber amplifier at a part of light transmission link.

Next, each of steps included in the process (1) and the process (2), especially the process (1), will be described in detail.

In the process (1), a hollow structure, corresponding to the clad region, for example cylinder, is obtained through the first step; and in the process (2), the hollow structure made of two concentric layers respectively corresponding to the clad region and the outer core layer is obtained through the first step. The hollow tube may be fabricated while allowing the polymerization of the monomer to proceed at the same time, or may be fabricated by melt extrusion molding or injection molding of a polymer.

The former process is typically described in International Patent Publication WO93/08488, Japanese patent No. 3332922 or the like. In particular, a polymerizable composition is put into a cylindrical polymerization vessel or a pipe formed of a fluorine polymer, and then polymerization is carried out while rotating (preferably while keeping the axis of the cylinder horizontally) the vessel or the pipe supported by a vessel, referred to as “rotational polymerization” hereinafter, to thereby form a cylinder having one layer made of a polymer or a cylinder having two concentric layers. Before being poured into the vessel, the composition may be filtered to remove powder dusts from the composition. A suitable temperature and period for the polymerization may vary depending on species of the monomer to be employed. In general, the polymerization is preferably carried out at 60 to 150 degrees Celsius for 5 to 24 hours. The monomer used herein may be pre-polymerized before the polymerization so as to raise the viscosity thereof as described in JPA No. 1996-110419. Since the obtained hollow structure may be deformative when the vessel may get distorted by rotation, it is preferable to use a metal or glass vessel having a sufficient rigidity.

The hollow tube composed of a polymer can be fabricated also by placing a pellet-formed or powdery resin (preferably fluorine-containing resin) into a cylindrical reactor, closing the reactor at both ends, heating the reactor up to a temperature higher than the melting point of the resin while keeping on rotating the reactor (preferably so as to keep the axis of the cylinder horizontally), to thereby allow the resin to melt. During this process, it is preferable to proceed the polymerization under an inert gas atmosphere by filling the polymerization reactor with nitrogen, argon or the like, or to preliminarily allow the resin to thoroughly dry, in order to avoid thermal oxidation and/or thermal decomposition of the molten resin.

For the case where the clad region is formed by melt extrusion of the polymer, it is also allowable to produce the polymer, and then to obtain a structured component of a desired geometry (cylindrical form in this embodiment) by molding technique such as extrusion molding. The melt extrusion machines available herein are classified into two types, inner sizing die system and outer die vacuum suction system.

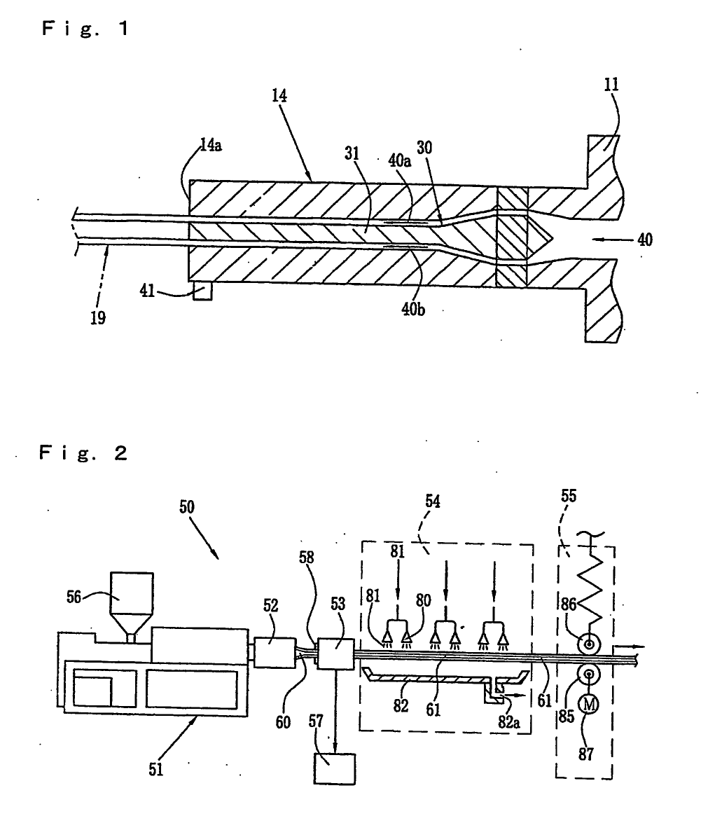

Outline of the inner sizing die system will be explained referring to FIG. 1 which is a schematic sectional view of an exemplary configuration of a melt extrusion molding machine based on the inner sizing die system.

A source polymer 40 for forming the clad region is extruded by a single screw extruder having a bent (not shown) out through a main unit 11 towards a die block 14. The die block 14 has a guide 30, inserted therein, for introducing the source polymer 40 into flow paths 40a, 40b. The source polymer 40 passes by the guide 30, flows through the flow paths 40a, 40b formed between the die block 14 and an inner rod 31, extruded out from the exit 14a of the die, to thereby form a cylindrical hollow clad 19. The extrusion speed of the clad 19 is not specifically limited, where it is preferably set within a range from 1 cm/min to 100 cm/min in view of shape stability and productivity.

The die block 14 is preferably equipped with a heating device for heating the source polymer 40. In one possible configuration, one or two heating devices (device using steam, heat medium oil, electric heater, etc.) are disposed so as to surround the die block 14 along the direction of advancement of the source polymer 40. On the other hand, it is preferable to attach a temperature sensor 41 at the exit 14a of the die, and to use the temperature sensor 41 to control the temperature of the clad 19 at the exit 14a of the die. The temperature is preferably adjusted not higher than the glass transition point of the source polymer 40 in view of keeping a uniform geometry of the clad 19. The temperature of the clad 19 is also preferably adjusted not lower than 40° C. in view of suppressing variation in the geometry due to abrupt temperature change. The temperature control for the clad 19 is attainable by attaching a cooling unit (device using liquid such as water, anti-freezing fluid or oil, or based on electronic cooling) to the die block 14, or by natural air cooling of the die 14. For the case where the heating device is provided to the die block, the cooling unit is preferably disposed on the downstream side of the heating device.

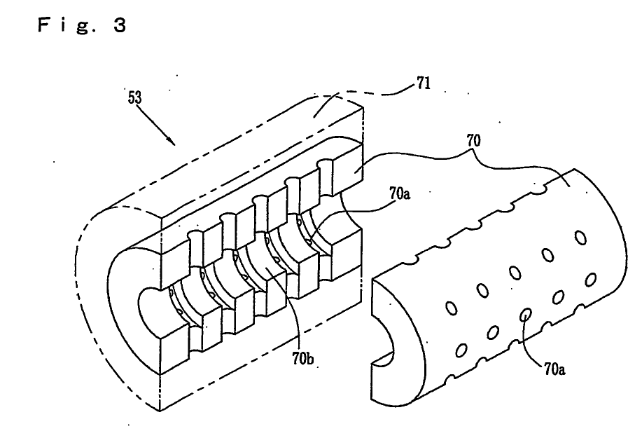

Next paragraphs will describe an outline of the forming process based on the outer die vacuum suction system referring to FIGS. 2 and 3, where the former shows an exemplary configuration of a manufacturing line of the melt extrusion molding machine based on the outer die vacuum suction system, and the latter is a perspective view of a molding die 53 available therefore.

A manufacturing line 50 shown in FIG. 2 comprises a melt extrusion machine 51, a pushing die 52, a molding die 53, a cooling unit 54 and drawing device 55. The source polymer charged through a pellet charge hopper (referred to as a hopper, hereinafter) 56 is melted inside the melt extrusion machine 51, extruded by the pushing die 52, and fed into the molding die 53. The extrusion speed S preferably satisfy a relation of 0.1≦S (m/min)≦10, more preferably 0.3≦S (m/min)≦5.0, and most preferably 0.4≦S (m/min)≦1.0, while not being limited to these ranges.

As shown in FIG. 3, the molding die 53 is equipped with a molding tube 70, through which the molten resin 60 is allowed to pass and molded to produce a cylindrical clad 61. The molding tube 70 has many suction holes 70a formed thereon, and allows the outer wall surface of the clad 61 to be pressed onto the molding surface (inner wall) 70b of the molding tube 70 when the reduced-pressure chamber 71 provided so as to surround the molding tube 70 is evacuated using a vacuum pump 57 (see FIG. 2), to thereby produce the clad 61 having a uniform thickness. The pressure inside the reduced-pressure chamber 71 is preferably adjusted within a range from 20 kPa to 50 kPa, while being not limiter thereto. It is preferable to attach a throat (outer diameter limiting member) 58 for limiting the outer diameter of the clad 61 at the entrance of the molding die 53. The clad 61 after being shaped by the molding die 53 is then sent to the cooling unit 54. The cooling unit 54 has a number of nozzles 80, from which cooling water 81 is ejected towards the clad 61 to thereby cool and solidify the clad 61. It is also allowable to collect the cooling water 81 on a receiving pan 82 and to discharge through a discharge port 82a. The clad 61 is drawn by the drawing device 55 out from the cooling unit 54. The drawing device 55 comprises a drive roller 85 and pressurizing roller 86. The drive roller 85 is connected to a motor 87, so as to make it possible to control the drawing speed of the clad 61. The pressurizing roller 86 disposed so as to oppose with the drive roller 85 while placing the clad 61 in between makes it possible to finely correct even a slight dislocation of the clad 61. By controlling the drawing speed of the drive roller 85 and the extrusion speed of the melt extrusion molding machine 51, or by finely adjusting displacement of the clad 61, the clad 61 can be fabricated with an excellent uniformity in the geometry thereof, especially in the thickness.

The clad region may be composed of a plurality of layers so as to have a variety of functions such as improved mechanical strength and flame retardancy. It is also preferable to fabricate the hollow tube so as to have an arithmetic mean roughness of the inner wall thereof within a predetermined range, and to cover the outer surface thereof with a fluorine-containing resin or the like.

The outer diameter of the resultant clad region preferably satisfies the relation of D₁ (mm)≦50 in view of optical characteristics and productivity, and more preferably satisfies the relation of 10≦D₁ (mm)≦30. The thickness t of the clad region can be determined arbitrarily in consideration of object and core/cladding ratio of the plastic optical fiber and others. For example, in a preform for a plastic optical fiber having an outer diameter of the clad region of 20 mm, the thickness t of the clad region preferably satisfies the relation of 2≦t (mm)≦20. The present invention is, however, by no means limited to the above-described ranges.

Specific examples of the polymerizable monomers available for forming the outer core layer are identical to those described in relation to the core region.

The outer core layer is provided mainly for producing the core region, may have a least necessary thickness so as to facilitate the block polymerization of the core region, and may exist simply as the core region after being united with the inner core region having a certain refractive index with progress of the block polymerization, rather than existing as an independent layer. A thickness of only as small as 1 mm or more will therefore be necessary for the outer core layer provided in advance of the formation of the core region, where the upper limit thereof is selectable depending on the target size of the preform, because the thickness can be increased to a degree as far as a space sufficient for producing a desired index gradation can be accomplished therein is secured.

The mono-layered or double-layered hollow cylinder desirably has a bottom portion, so as that a material for the core region can be poured into the cylinder in the second step. The preferred material for the bottom portion is a material having a good affinity and adhesiveness with the polymer of the cylinder. The bottom portion may be formed of the same polymer as that of the cylinder. For example, the bottom potion can be produced by pouring a small amount of monomer into a vessel before or after carrying out rotational polymerization; and carrying out polymerization of the monomer with still standing the vessel.

For the purpose of completely reaction of the residual monomer or the residual polymerization initiator, it is allowable after such rotational polymerization to carry out annealing at a temperature higher than the polymerization temperature, or to remove non-polymerized components.

The core region is prepared through the second step. From the view point of reducing residues, the interfacial gel polymerization process which is solvent-free is desirable. In the interfacial gel polymerization process, the polymerization proceeds along the radial direction of the cylinder from the inner surface thereof, where viscosity is high, towards the center due to gel effect.

When the polymerizable composition containing a refractive index adjuster is used in the polymerization, the polymerization proceeds in a way such that the monomer having a higher affinity to the polymer, of which the cylinder is made, exists in larger ratio on the inner wall of the cylinder and then polymerizes, so as to produce on the outer periphery a polymer having a lower content of the refractive index adjuster. Ratio of the refractive index adjuster in the resultant polymer increases towards the center. This successfully creates the distribution of refractive index adjuster and thus introduces the distribution of refractive index within the area corresponding to the core region.

Not only the distribution of refractive index is induced into the area corresponding to the core region through the second step, but also the distribution of thermal behavior since the areas having different refractive indices are also different in the thermal behavior. If the polymerization in the second step is carried out at a constant temperature, the response property against the volume shrinkage which occurs in the polymerization reaction process may vary depending on the thermal behaviors, and thereby air bubbles or micro-gaps may generate in the obtained preform, and drawing under heating of such preform may result in that the obtained fiber has a lot of air bubbles formed therein. If the polymerization in the second step is carried out at too low temperature, the productivity may considerably lower due to low polymerization efficiency, or the light transmission performance of the resultant optical member may lower due to incomplete polymerization. On the contrary, if the polymerization in the second step is carried out at too high initial polymerization temperature, the initial polymerization rate may be so fast that the volume shrinkage of the core region cannot be reduced by a relaxation response, and as a result a lot of air bubbles may generate in the core region. Therefore, it is preferable to carry out the polymerization at a proper temperature and to carry out the after-treatment at a proper temperature respectively decided in consideration of a boiling temperature or a Tg of the used monomers. The after-treatment is desirably carried out at a temperature higher than the Tg of the polymer. For the case where typical methacrylic esters are used as the monomer, the polymerization is desirably carried out at a temperature within a range from 50 to 160° C., more desirably at a temperature within a range from 70 to 140° C. It is also preferable to carry out the polymerization under inert gas atmosphere applied pressure in order to improve response property against the volume shrinkage which occurs in the polymerization. Using the polymerizable monomer dehydrated and deaerated under reduces pressure may prevent an occurrence of air bubbling during the polymerization. The composition may be filtered to remove powder dusts from the composition before being poured into the hollow portion.

Preferred range of polymerization temperature and polymerization period may vary according to species of the used polymerizable monomers, however, in general, the polymerization is preferably carried out at a temperature within a range from 60 to 160° C. for a period within a range from 5 to 72 hours. For the case where the polymerizable composition of the second embodiment is used, first, the polymerization may be carried out at a temperature within a range from 80 to 110° C. for a period within a range from 4 to 24 hours, and secondly the polymerization may be carried out at a temperature within a range from 120 to 140° C. for a period within from 24 to 48 hours. Preferred polymerization initiator to be used may be varied depending on the polymerization temperature or the polymerization period, and under the above mentioned condition, high-temperature-decomposition-type polymerization initiators such as di-tert-butylperoxide (PBD) or 2,2′-azobis(2,4,4-trimethylpentane) are desirable. The temperature elevation may be effected either in a step-wise manner or in a continuous manner, where shorter time for the elevation is preferable.

In the second step, it is preferable to carry out the polymerization under pressure (herein after referred as “pressurized polymerization”). In case of the pressurized polymerization, it is preferable to place the mono-layered or double-layered cylinder in the hollow space of a jig, and to carry out the polymerization while keeping the cylinder as being supported by the jig. While the pressurized polymerization is being carried out in a hollow portion of the structure corresponding to the clad region, the structure is kept as being inserted in the hollow space of the jig, and the jig prevents the shape of the structure from being deformed due to pressure. The jig is preferably shaped as having a hollow space in which the structure can be inserted, and the hollow space preferably has a profile similar to that of the structure. Since the structure corresponding to the clad region is formed in a cylindrical form in the present embodiment, it is preferable that also the jig has a cylindrical form. The jig can suppress deformation of the mono-layered or double-layered cylinder during the pressurized polymerization, and supports the cylinder so as to relax the shrinkage of the area corresponding to the core region with the progress of the pressurized polymerization. It is preferable that the jig has a hollow space having a diameter larger than the outer diameter of the mono-layered or double layered cylinder, and that the jig supports the cylinder corresponding to the clad region in a non-adhered manner. Since the jig has a cylindrical form in the present embodiment, the inner diameter of the jig is preferably larger by 0.1 to 40% than the outer diameter of the cylinder corresponding to the clad region, and more preferably larger by 10 to 20%.

The mono-layered or double-layered cylinder can be placed in a polymerization vessel while being inserted in the hollow space of the jig. In the polymerization vessel, it is preferable that the mono- or double-layered cylinder is housed so as to vertically align the height-wise direction thereof. After the cylinder is placed, while being supported by the jig, in the polymerization vessel, the polymerization vessel is pressurized. The pressurizing of the polymerization vessel is preferably carried out using an inert gas such as nitrogen, and thus the pressurized polymerization preferably is carried out under an inert gas atmosphere. While a preferable range of the pressure during the polymerization may vary with species of the monomer, it is generally 0.05 to 1.0 MPa or around.

A preform for the plastic optical member can be obtained through the first and second steps.

A preform for the plastic optical member can be obtained through the first and second steps. It is to be noted now that the outer core layer may be formed of plural layers. Further it is to be noted now that the outer core layer may be united with the inner core region and not be able to be distinguished from the inner core region after being processed through the third step.

In the third step, a desired optical member can be obtained by processing the preform produced through above steps. For example, slicing the preform gives plate-shaped or column-shaped planar lens, and drawing under fusion gives plastic optical fiber.

Optical fibers can be produced by heat drawing in the third step. While the heating temperature during the drawing may properly be determined in consideration of source material of the preform, a generally preferable range thereof is 180 to 250 degrees Celsius. Conditions for the drawing (drawing temperature, etc.) may properly be determined in consideration of diameter of the obtained preform, desirable diameter of the plastic optical fiber, and source materials used. In particular for the optical fiber having a graded refractive index, the drawing spinning and heating should be carried out uniformly so as not to ruin the distribution profile of the refractive index which varies along the radial direction. It is therefore preferable to heat the preform using a cylindrical heating oven capable of uniformly heating it in the sectional direction thereof, and to draw the preform into fiber using a draw-spinning apparatus which has an aligning mechanism for keeping the center position constant. It is also preferable to heat the preform using a cylindrical heating oven that whose inside has a distribution of temperature. It is preferred that the melt portion in the preform is narrow, since as the melting portion is narrower, the graded refractive index structure is harder to be distorted and the yield is higher. In particular, the preform may be preheated before being melted and slowly cooled after being melted, so as to have a narrow melting portion. The heating source for melting the preform is desirably selected from apparatuses capable of giving high energy to a narrow area, such as lasers.

For the fiber keeping the linearity and the circularity, it is preferable to draw the preform into fiber using a draw-spinning apparatus which has an aligning mechanism for keeping the center position constant. The orientation of the polymer in the fiber can be controlled by a drawing condition. And the mechanical properties such as a bending property or thermal shrinkage of the drawn fiber can be also controlled.

The drawing tension can be set to 10 g or above in order to orient molten plastic as described in JPA No. 1995-234322, and preferably set to 100 g or below so that strain does not remain after the spinning as disclosed in JPA No. 1995-234324. It is also allowable to employ a method having a pre-heating step prior to the drawing.

The bending property and the edgewise pressure property of the fiber can be improved when the breaking stretch and the hardness of a raw fiber would be respectively within a range described in JPA No. 1995-244220. The transmission quality of the fiber can be improved when the fiber has an outer layer, having a low refractive index, which can function as a reflective layer, as described in JPA No. 1996-54521.

The plastic optical fiber after being processed in the third step can directly be subjected, without any modification, to various applications. The fiber may also be subjected to various applications in a form of having on the outer surface thereof a covering layer or fibrous layer, and/or in a form having a plurality of fibers bundled for the purpose of protection or reinforcement. For the case where a coating is provided to the element wire, the covering process is such that running the element wire through a pair of opposing dies which has a through-hole for passing the element fiber, filling a molten polymer for the coating between the opposing dies, and moving the element fiber between the dies. The covering layer is preferably not fused with the element fiber in view of preventing the inner element fiber from being stressed by bending. In the covering process, the element fiber may be thermally damaged typically through contacting with the molten polymer. It is therefore preferable to set the moving speed of the element fiber so as to minimize the thermal damage, and to select a polymer for forming the covering layer which can be melted at a low temperature range. The thickness of the covering layer can be adjusted in consideration of fusing temperature of polymer for forming the covering layer, drawing speed of the element fiber, and cooling temperature of the covering layer.

Other known methods for forming the covering layer on the fiber include a method by which a monomer coated on the optical member is polymerized, a method of winding a sheet around, and a method of passing the optical member into a hollow pipe obtained by extrusion molding.

Coverage of the element fiber enables producing of plastic optical fiber cable. Styles of the coverage include contact coverage in which plastic optical fiber is covered with a cover material so that the boundary of the both comes into close contact over the entire circumference; and loose coverage having a gap at the boundary of the cover material and plastic optical fiber. The contact coverage is generally preferable since the loose coverage tends to allow water to enter into the gap from the end of the cover layer when a part of the cover layer is peeled off typically at the coupling region with a connector, and to diffuse along the longitudinal direction thereof. The loose coverage in which the coverage and element fiber are not brought into close contact, however, is preferably used in some purposes since the cover layer can relieve most of damages such as stress or heat applied to the cable, and can thus reduce damages given on the element fiber. The diffusion of water from the end plane is avoidable by filling the gap with a fluid gel-form, semi-solid or powdery material. The coverage with higher performance will be obtained if the semi-solid or powdery material has both of a function for providing water diffusion and a function other than the water-diffusion-providing-function, such as functions for improving heat resistance, mechanical properties or the like.

The loose coverage can be obtained by adjusting position of a head nipple of a crosshead die, and by controlling a decompression device so as to form the gap layer. The thickness of the gap layer can be adjusted by controlling the thickness of the nipple, or compressing/decompressing the gap layer.

It is further allowable to provide another cover layer (secondary cover layer) so as to surround the existing cover layer (primary cover layer). The secondary cover layer may be added with flame retarder, UV absorber, antioxidant, radical trapping agent, lubricant and so forth, which may be included also in the primary cover layer so far as a satisfactory level of the anti-moisture-permeability is ensured.

While there are known resins or additives containing bromine or other halogen or phosphorus as the flame retarder, those containing metal hydroxide are becoming a mainstream from the viewpoint of safety such as reduction in emission of toxic gas. The metal hydroxide has crystal water in the structure thereof and this makes it impossible to completely remove the adhered water in the production process, so that the flame-retardant coverage is preferably provided as an outer cover layer (secondary cover layer) surrounding the anti-moisture-permeability layer (primary cover layer) of the present invention.

It is still also allowable to stack cover layers having a plurality of functions. For example, besides flame retardation, it is allowable to provide a barrier layer for blocking moisture absorption by the element fiber or moisture absorbent for removing water, which is typified by hygroscopic tape or hygroscopic gel, within or between the cover layers. It is still also allowable to provide a flexible material layer for releasing stress under bending, a buffer material such as foaming layer, and a reinforcing layer for raising rigidity, all of which may be selected by purposes. Besides resin, a highly-elastic fiber (so-called tensile strength fiber) and/or a wire material such as highly-rigid metal wire are preferably added as a structural material to a thermoplastic resin, which reinforces the mechanical strength of the obtained cable.

Examples of the tensile strength fiber include aramid fiber, polyester fiber and polyamide fiber. Examples of the metal wire include stainless wire, zinc alloy wire and copper wire. Both of which are by no means limited to those described in the above. Any other protective armor such as metal tube, subsidiary wire for aerial cabling, and mechanisms for improving workability during wiring can be incorporated.

Types of the cable include collective cable having element fibers concentrically bundled; so-called tape conductor having element fibers linearly aligned therein; and collective cable further bundling them by press winding or wrapping sheath; all which can be properly selected depending on applications.

The cables comprising the fibers of the present invention may have a higher tolerance for an axis misalignment than those of the previous cables. Thus, the cables can be used for butt connections, however, in such cases, optical connectors are desirably used at the ends, so as to fix the connection portions certainly. Various types of commercially available connectors such as a PN, SMA, SMI, F05, MU, FC or SC type connector can be used.

The optical member of the present invention is available as an optical fiber cable for use in a system for transmitting light signal, which system comprises various light-emitting element, light-switch, optical isolator, optical integrated circular, light-receiving element, other optical fiber, optical bus, optical star coupler, light signal processing device, optical connector for connection and so forth. Any known technologies may be applicable while making reference to “Purasuchikku Oputicaru Faiba no Kiso to Jissai (Basics and Practice of Plastic Optical Fiber)”, published by N.T.S. Co., Ltd.; pages 110 to 127 of “NIKKEI ELECTRONICS” vol. 2001, 12, 3 or the like. The optical member of the present invention may be combined with any technology described in the above mentioned documents, and the combinations may form light transmission systems for short distance such as high-speed data communications or controls without electro magnetic wave. More specifically, such combinations may form internal wirings in computers or various digital equipments; internal wirings in vehicles or ships; optical links between optical terminals and digital equipments or between digital equipments; and indoor or interregional optical LANs in isolated houses, multiple houses, factories, offices, hospitals, schools.

Furthermore, the optical member of the present invention may be combined with any technique described in “High-Uniformity Star Coupler Using Diffused Light Transmission”, IEICE TRANS. ELECTRON., VOL. E84-C, No. 3, MARCH 2001, p. 339-344; or “HIKARI SHITOBASU GIJYUTSU NIYORU INTACONEKUSYON (Interconnections by optical sheet buses)” Journal of Japan Institute of Electronics Packaging Vol. 3, No. 6, 2000, p. 476-480; optical bus typically described in JPA Nos. 1998-123350, 2002-90571 or 2001-290055; optical branching/coupling device typically described in JPA No. 2001-74971, 2000-329962, 2001-74966, 2001-74968, 2001-318263 or 2001-311840; optical star coupler typically described in JPA No. 2000-241655; light signal transmission device and optical data bus system typically described in JPA No. 2002-62457, 2002-101044 or 2001-305395; light signal processor typically described in JPA No. 2002-23011; light signal cross-connection system typically described in JPA No. 2001-86537; optical transmission system typically described in JPA No. 2002-26815; or multi-function system typically described in JPA No. 2001-339554 or 2001-339555; any light guide, any optical turnout and crossing, any optical coupler, any optical compiling filter or any optical branching filter; and such combinations may form improved optical transmission systems using multiple sending and receiving.

Outside of the above mentioned applications, the optical member of the present invention may be used in the various technical fields such as lighting systems, energy transmitters, illuminations or sensors.

### EXAMPLE

The present invention will specifically be described referring to the specific examples. It is to be noted that any materials, reagents, ratio of use, operations and so forth can be properly altered without departing from the spirit of the present invention. The scope of the present invention is therefore by no means limited to the specific examples shown below.

### Example 1-1

### Synthesis of Compound D-2

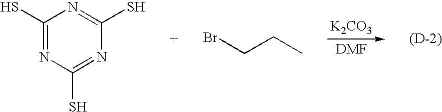

An 8.00 g (45.1 mmol) of thiocyanuric acid and a 17.46 g ( [symbol] 42 mol) of 1-bromopropane were dissolved in a 60 ml of dimethylformamide, and after added a 22.5 g (0.163 mol) of potassium carbonate, the solution was stirred at 70° C. for 4 hours. The reaction mixture was added a 100 ml of water and extracted with ethyl acetate. The extraction was added magnesium sulfate and dried. The magnesium sulfate was removed by filtration and the filtrate was evaporated to dryness under reduced pressure. The residue was purified by a silica gel chromatography with a mixed solvent of hexane and methylene chloride in 7 to 1 volume ration, to give a 10.0 g of Compound D-2 in a 73% yield. The structure of the compound was identified by ¹H-NMR and FAB-MS and the refractive index was measured.

NMR(300 MHz, CDCl₃, d ppm): 3.10(t,2H), 1.80-1.68(m,2H), 1.04(t,3H).

Refractive index=1.58 (measurement wavelength: 589 nm, temperature: 23° C.).

### Example 1-2

### Synthesis of Compound D-16

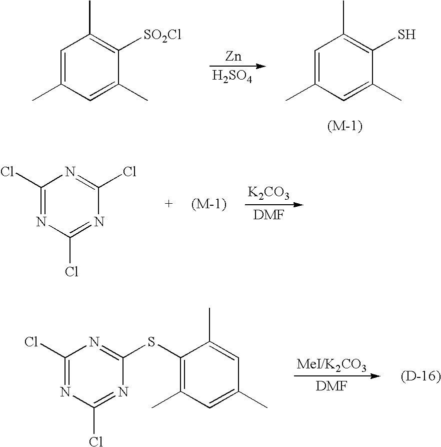 (Synthesis of Intermediate M-1)

A 98.1 g (0.448 mol) of 2-mesitylene sulfonyl chloride was dissolved in a 530 ml of tetrahydrofuran and after added a 90 g of ices and a 90 g of water, the solution was added a 61.2 ml of conc. sulfuric acid. Under cooling with ices, the mixed solution was gradually added a 102.15 g (1.562 mol) of zinc and refluxed under heating for 8 hours. After the insoluble matter was removed by Celite filtration and the filtrate was evaporated to dryness under reduced pressure. The crude product was purified by distillation under reduced pressure (major fraction: 72° C. at 2 mmHg), to give a 56.04 g of Compound M-1 in an 82% yield.

(Synthesis of Compound D-6)

A 6.00 g (32.5 mmol) of thiocyanuric acid chloride and a 5.19 g (34.1 mmol) of Intermediate M-1 were dissolved in a 50 ml of dimethylformamide, and after added a 8.97 g (65.0 mmol) of potassium carbonate, the solution was stirred at 50° C. for 3 hours. Subsequently, the reaction mixture was added a 9.69 g (68.3 mmol) of methane iodide and a 17.94 g (130 mmol) of potassium carbonate, and stirred at 80° C. for 5 hours. The reaction mixture was added a 100 ml of water and extracted with ethyl acetate. The extraction was added magnesium sulfate and dried. The magnesium sulfate was removed by filtration and the filtrate was evaporated to dryness under reduced pressure. The residue was purified by a silica gel chromatography with a mixed solvent of hexane and methylene chloride within 10/1 to 5/1 volume ration, to give a 6.41 g of Compound D-16 in a 61% yield.

NMR(300 MHz, CDCl₃, d ppm): 6.90(s,2H), 3.13(s,6H), 2.25(s,3H), 2.19(s,6H).

Compound D-16 refractive index=1.65 (measurement wavelength: 589 nm, temperature: 23° C.)

### Example 1-3

(Production of Clad Region)

An amount of a mixture containing deuterated methyl methacrylate (MMA-d8), from which a polymerization inhibitor, hydroquinone monomethyl ether was remove and water was removed by 80 ppm, a 0.5 wt %, with respect to the MMA-d8 weight, of benzoyl peroxide (BPO) as a polymerization initiator and a 0.28 wt %, with respect to the MMA-d8 weight, of n-laurylmercaptan as a chain transfer agent was poured into a sufficiently-rigid cylindrical vessel having 22 mm in inner diameter and 600 mm in length, which inner diameter corresponds with the outer diameter of the preform to be obtained. The vessel was placed in the water bath at 80° C. and the mixture was shaken and pre-polymerized at 80° C. for 2 hours. Subsequently, the mixture was allowed to polymerize under heating at 80° C. for three hours while holding the vessel horizontally and rotating it at a speed of rotation of 3,000 rpm, which was followed by annealing at 100° C. for 24 hours to thereby obtain hollow cylinder made of the polymer of MMA-d8.

(Production of Core Region)

Next, a mixed solution containing MMA-d8, from which a polymerization inhibitor, hydroquinone monomethyl ether was remove and water was removed by 80 ppm, and 10 wt %, with respect to the MMA-d8 weight, of Compound D-2, Compound D-16, Comparative Compound R-1 or Comparative Compound R-2 as a refractive index adjuster was prepared. The mixed solution was directly poured into the hollow region of the obtained hollow cylinder while being filtered through a membrane filter made of tetrafluoroethylene, having a pore size of 0.2 μm. A 0.016 wt %, with respect to the MMA-d8 weight, of PBD as a polymerization initiator and 0.27 wt %, with respect to the MMA-d8 weight, of n-laurylmercaptan as a chain transfer agent, having a coefficient of 0.8 in this system, were added to the mixed solution. A cylinder thus filled with the mixed solution was housed in a glass tube having a diameter larger by 9% than the outer diameter of the cylinder, and was then allowed to stand vertically in a pressure polymerization reactor. The inner atmosphere of the pressure polymerization reactor was then purged with nitrogen, pressurized up to 0.6 MPa, and the heat polymerization was allowed to proceed at 100° C. for 48 hours and subsequently 120° C. for 24 hours with keeping the pressured atmosphere to thereby obtain the preform.

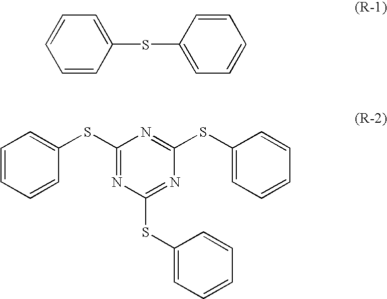

The obtained preforms observed when the polymerization completed were found to have no air bubbles contained therein which possibly introduced by volume shrinkage. The preforms were drawn by thermal drawing at 230° C. so as to produce plastic optical fibers having a diameter of approx. 700 to 800 μm. The preforms were not found to include air bubbles during the drawing, which contributed to successfully obtain the fiber of 300 m long in a stable manner.

The transmission losses at 650 nm or 850 nm of the obtained plastic optical fibers were shown in Table 1-1.

### Example 1-4

As a monomer for a clad or a core region, a mixture of MMA-8, from which a polymerization inhibitor, hydroquinone monomethyl ether was remove and water was removed by 80 ppm, and t-BMA-d14 in a 1/1 weight ration was used. And a 10 wt % of the dopant, Compound D-2, Compound D-3, Comparative Compound R-1 or Comparative Compound R-2, was added to the monomer mixture. Several plastic optical fibers were produced in the same manner as Example 1-3 except for these.

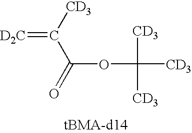

The obtained preforms observed when the polymerization completed were found to have no air bubbles contained therein which possibly introduced by volume shrinkage. The preforms were drawn by thermal drawing at 230° C. so as to produce plastic optical fibers having a diameter of approx. 700 to 800 μm. The preforms were not found to include air bubbles during the drawing, which contributed to successfully obtain the fiber of 300 m long in a stable manner.

The transmission losses at 650 nm or 850 nm of the obtained plastic optical fibers were shown in Table 1-2.

TABLE 1-1

| | | Transmission loss | Transmission loss |
|---|---|---|---|
| | | [dB/km] | [dB/km] |
| Monomer | Dopant | (at 650 nm) | (at 850 nm) |
| MMA-d8 | D-2 | 99 | 199 |
| MMA-d8 | D-3 | 97 | 198 |
| MMA-d8 | D-16 | 102 | 200 |
| MMA-d8 | R-1 | 103 | 710 |
| MMA-d8 | R-2 | 100 | 880 |

TABLE 1-2

| | | Transmission loss | Transmission loss |
|---|---|---|---|
| | | [dB/km] | [dB/km] |
| Monomer | Dopant | (at 650 nm) | (at 850 nm) |
| MMA-d8/tBMA-d14 | D-2 | 98 | 201 |
| (1:1) | | | |
| MMA-d8/tBMA-d14 | D-3 | 99 | 199 |
| (1:1) | | | |
| MMA-d8/tBMA-d14 | D-16 | 99 | 200 |
| (1:1) | | | |
| MMA-d8/tBMA-d14 | R-1 | 105 | 725 |
| (1:1) | | | |
| MMA-d8/tBMA-d14 | R-2 | 101 | 800 |
| (1:1) | | | |

As shown in tables, it may be understood that using the thio compound selected a particular group such as Compound D-1 or D-2 as a dopant, a plastic optical fiber having a smaller transmission loss at both wavelengths, especially at 850 nm, could be obtained in comparison with using the other compound such as Compound R-1 or R-2.

### Examples 2-1 to 2-4 and Comparative Examples 2-1 ad 2-2

(Production of Clad Region)

An amount of a monomer mixture containing hexafluoro isopropyl methacrylate (6FM) and t-butyl methacrylate-(t-BMA), from which a polymerization inhibitor, hydroquinone monomethyl ether was remove and water was removed by 80 ppm, in a 50/50 weight ration, a 0.5 wt %, with respect to the monomer mixture weight, of methylazobisisobutylate (MAIB) as a polymerization initiator and a 0.28 wt %, with respect to the monomer mixture weight, of n-laurylmercaptan as a chain transfer agent was poured into a sufficiently-rigid cylindrical vessel having 22 mm in inner diameter and 600 mm in length, which inner diameter corresponds with the outer diameter of the preform to be obtained. The vessel was placed in the water bath at 70° C. and the mixture was shaken and pre-polymerized at 70° C. for 2 hours. Subsequently, the mixture was allowed to polymerize under heating at 70° C. for three hours while holding the vessel horizontally and rotating it at a speed of rotation of 3,000 rpm, which was followed by annealing at 90° C. for 24 hours to thereby obtain hollow cylinder made of the copolymer of 6FM and t-BMA.

(Production of Core Region)

Next, a solution of a monomer mixture of MMA-d8 and t-BMA, from which a polymerization inhibitor, hydroquinone monomethyl ether was remove and water was removed by 80 ppm, in a 50/50 weight ration, and 9 wt %, with respect to the monomer mixture weight, of Compound D-3 as a refractive index adjuster was prepared. The mixed solution was directly poured into the hollow region of the obtained hollow cylinder while being filtered through a membrane filter made of tetrafluoroethylene, having a pore size of 0.2 μm. A 0.016 wt %, with respect to the monomer mixture weight, of PBD as a polymerization initiator and 0.27 wt %, with respect to the monomer mixture weight, of n-laurylmercaptan as a chain transfer agent, having a coefficient of 0.8 in this system, were added to the mixed solution. A cylinder thus filled with the mixed solution was housed in a glass tube having a diameter larger by 9% than the outer diameter of the cylinder, and was then allowed to stand vertically in a pressure polymerization reactor. The inner atmosphere of the pressure polymerization reactor was then purged with nitrogen, pressurized up to 0.2 MPa, and the heat polymerization was allowed to proceed at 90° C. for 48 hours and subsequently 120° C. for 24 hours with keeping the pressured atmosphere to thereby obtain the preform (Example 2-1).

Several preforms were produced in the same manner as Example 2-1 except that Compound D-5, Compound D-6, Compound D-20 Comparative Compound R-1 and Comparative Compound R-2 were used respectively in the place of Compound D-3 as a dopant. However, Comparative Compound R-2 was not dissolved in the monomer mixture even though under heating.

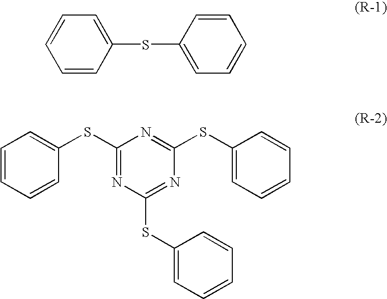

The obtained preforms, Examples 2-1 to 2-4, observed when the polymerization completed were found to have no air bubbles contained therein which possibly introduced by volume shrinkage. The preforms were drawn by thermal drawing at 230° C. so as to produce plastic optical fibers having a diameter of approx. 700 to 800 μm. The preforms were not found to include air bubbles during the drawing.

The transmission losses at 650 nm or 850 nm, the transmission bands at 650 nm and the transmission loss increases at 850 nm after being left at 50° C. under 95% RH for 150 hours of the obtained plastic optical fibers were shown in Table 2-1.

### Examples 2-5 to 2-8 and Comparative Examples 2-3 and 2-4

A mixture of deuterated hexafluoroisopropyl methacrylate (6FM-d5) and deuterated t-butyl methacrylate (t-BMA-d14), from which a polymerization inhibitor, hydroquinone monomethyl ether was remove and water was removed by 80 ppm, in a 50/50 weight ration was used as a monomer for a clad or a core region. And a 9 wt % of the dopant, Compound D-3, Compound D-5, Compound D-6, Compound D-20, Comparative Compound R-1 or Comparative Compound R-2, were added to the monomer mixture respectively. Several plastic optical fibers were produced in the same manner as Example 2-1 except for these.

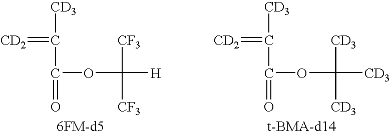

The obtained preforms, Examples 2-5 to 2-8 observed when the polymerization completed were found to have no air bubbles contained therein which possibly introduced by volume shrinkage. The preforms were drawn by thermal drawing at 210° C. so as to produce plastic optical fibers having a diameter of approx. 700 to 800 μm. The preforms were not found to include air bubbles during the drawing, which contributed to successfully obtain the fiber of 300 m long in a stable manner.

The transmission losses at 650 nm or 850 nm, the transmission bands at 650 nm and the transmission loss increases at 850 nm after being left at 50° C. under 95% RH for 150 hours of the obtained plastic optical fibers were shown in Table 2-2.

TABLE 2-1

| | | | | | Trans- |
|---|---|---|---|---|---|
| | | | | | mission |
| | | Transmission loss | | Transmission | loss |
| Example | | (dB/km) | | Band | increase |
| No. | Dopant | 650 nm | 850 nm | GHz · 100 m | (dB/km) |
| 2-1 | D-3 | 154 | 1530 | 2 | 180 |
| 2-2 | D-5 | 165 | 1480 | 2 | 183 |
| 2-3 | D-6 | 155 | 1560 | 2 | 181 |
| 2-4 | D-20 | 161 | 1510 | 2 | 178 |
| Compara- | R-1 | 3290 | 4940 | 1.2 | 450 |
| tive 2-1 | | | | | |
| Compara- | R-2 | incapable | incapable | incapable | incapable |
| tive 2-2 | | measure- | measure- | measure- | measure- |
| | | ment | ment | ment | ment |

TABLE 2-2

| | | | | | Trans- |
|---|---|---|---|---|---|
| | | | | | mission |
| | | Transmission loss | | Transmission | loss |
| Example | | (dB/km) | | band | increase |
| No. | Dopant | 650 nm | 850 nm | GHz · 100 m | (dB/km) |
| 2-5 | D-3 | 78 | 210 | 2 | 160 |
| 2-6 | D-5 | 71 | 203 | 2 | 163 |
| 2-7 | D-6 | 81 | 220 | 2 | 156 |
| 2-8 | D-20 | 67 | 198 | 2 | 167 |
| Compara- | R-1 | 2990 | 3980 | 1.2 | 523 |
| tive 2-3 | | | | | |
| Compara- | R-2 | Incapable | Incapable | Incapable | Incapable |
| tive 2-4 | | measure- | measure- | measure- | measure- |
| | | ment | ment | ment | ment |

As shown in tables, it may be understood that the combination of fluorine-containing matrix and a compound selected a particular group such as Compound D-3, D-5, D-6 or D-20 is excellent in compatibility, and a plastic optical fiber having low scattering loss and low transmission loss could be obtained. Furthermore in such a combination, it is allowable that the content of fluorine-containing matrix is large and that the transmission band is widened. And the optical fibers according to the second embodiment have a good moisture resistance.

### Example 2-9

A mixture of Monomer (A) shown bellow and Monomer (B) shown bellow in an 8/2 weight ration was used as a monomer for a clad or a core region. And a 9 wt % of the dopant, Compound D-3, was added to the monomer mixture. A plastic optical fiber was produced in the same manner as Example 2-1 except for these.

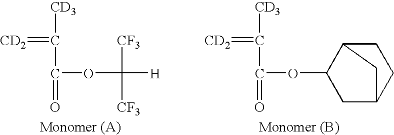

The obtained optical fiber was evaluated in the same manner as the described above. The result is shown bellow.

TABLE 2-3

| | | | | | Trans- |
|---|---|---|---|---|---|
| | | | | | mission |
| | | Transmission loss | | Transmission | loss |
| Example | | (dB/km) | | band | increase |
| No. | Dopant | 650 nm | 850 nm | GHz · 100 m | (dB/km) |
| 2-9 | D-3 | 90 | 350 | 2 | 133 |

### Example 2-10

A PVDF, manufactured by Sumitomo 3M, Dyneon THV220G, THV415G, THV500G), having a refractive index of 1.36, was melt extruded into a hollow cylinder shape to form a PVDF pipe corresponding to a clad region. The pipe was housed in a pipe and a mixed solution as same as the solution used as a material for a clad region in Example 2-9, containing a monomer mixture of Monomer (A) and Monomer (B) in an 8/2 weight ration, was poured into the hollow region of the obtained PVDF pipe. And an outer core region was produced by rotational polymerization of the mixed solution.

A mixed solution as same as the solution used as a material for a core region in Example 2-9, containing a monomer mixture of Monomer (A) and Monomer (B) in an 8/2 weight ration and a 9 wt % of a dopant, Compound D-3, was poured into the inside of the obtained outer core region. And an inner core region was produced by interfacial gel polymerization of the mixed solution. Thus, a preform was obtained. After that, an optical fiber was produced in the same manner as Examples 2-1.

The obtained optical fiber had the same excellent properties as those found in the optical fibers of Examples 2-1 to 2-9.

### INDUSTRIAL APPLICABILITY

As described above, according to the present invention, polymerizable compositions capable of forming optical members having low transmission loss and high thermostability can be provided. And optical members having low transmission loss and high thermostability can be provided. Novel thio compounds useful as an adjuster of refractive index used in producing optical members can be provided.

As described above, according to the present invention, polymerizable compositions, containing fluorine-containing methyl methacrylate, having low transmission loss at 850 nm and a large transmitting capacity can be provided. And fluorine-containing methyl methacrylate base optical members having low transmission loss at 850 nm and a large transmitting capacity can be obtained.

The present disclosure relates to subject matters contained in Japanese Patent Application No. 2003-000522, filed on Jan. 6, 2003, and in Japanese Patent Application No. 2003-029556, filed on Feb. 6, 2003, the contents of which are herein expressly incorporated by reference in its entirety.

1. An optical material comprising a matrix formed of a polymer and at least a compound selected from a group denoted by a formula (1a) or formula (2a); 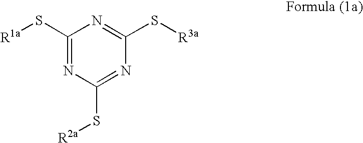
wherein R^{1a}, R^{2a} and R^{3a} respectively denote an optionally substituted alkyl group; 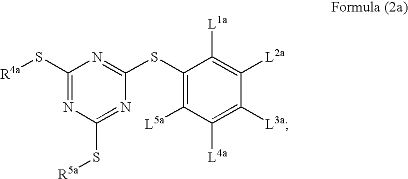
wherein R^{4a} and R^{5a} respectively denote an optionally substituted alkyl group; and L^{1a}, L^{2a}, L^{3a}, L^{4a} and L^{5a} respectively denote a hydrogen atom, a halogen atom, an optionally substituted alkyl group, an optionally substituted alkoxy group or an optionally substituted alkylthio group provided that at least two of L^{1a}, L^{2a}, L^{3a}, L^{4a} and L^{5a} denote a halogen atom, an optionally substituted alkyl group, an optionally substituted alkoxy group or an optionally substituted alkylthio group.

2. The optical material of claim 1 wherein the compound denoted by the formula (1a) or the formula (2a) having at least one fluorine atom.

3. The optical material of claim 1 used for a plastic optical fiber.

4. A polymerizable composition for producing an optical member comprising;
a polymerizable monomer composition and
at least a compound, having a different refractive index from that of the polymerizable monomer composition, which is selected from the group denoted by the formula (1a) or the formula (2a).

5. The polymerizable composition of claim 4 comprising a polymerization initiator.

6. An optical member produced by polymerization of a composition of claim 4, to form a region having a graded refractive index.

7. The optical member of claim 6 wherein the region having a graded refractive index along the direction from the center to the outside.

8. An optical fiber produced by drawing an optical member of claim 6.

9. A compound denoted by a formula (2a); 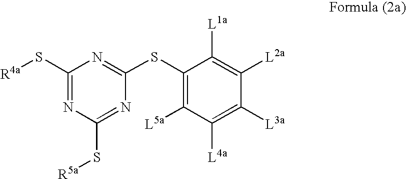
wherein R^{4a} and R^{5a} respectively denote an optionally substituted alkyl group; and L^{1a}, L^{2a}, L^{3a}, L^{4a} and L^{5a} respectively denote a hydrogen atom, a halogen atom, an optionally substituted alkyl group, an optionally substituted alkoxy group or an optionally substituted alkylthio group provided that at least two of L^{1a}, L^{2a}, L^{3a}, L^{4a} and L^{5a} denote a halogen atom, an optionally substituted alkyl group, an optionally substituted alkoxy group or an optionally substituted alkylthio group.

10. A compound denoted by a formula (3a); 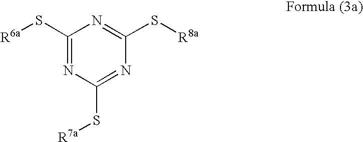
wherein R^{6a}, R^{7a} and R^{8a} respectively denote an optionally substituted branched alkyl group.

11. A polymerizable composition for producing an optical member comprising;
a polymerizable monomer composition comprising at least one polymerizable monomer denoted by a formula (1b); 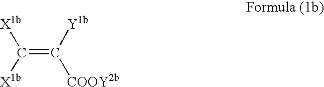
wherein X^{1b} is hydrogen (H) or deuterium (D) and two X^{1b}s may be same or different each other; Y^{1b} is H, D, fluorine (F) CH₃, CD₃ or CF₃; and Y^{2b} is a substituted or non-substituted C₁₋₇ alkyl group provided that Y^{2b} is a fluorine-containing C₁₋₇ alkyl group substituted with 1 to 15 fluorine atoms when Y^{1b} is H, D, CH₃ or CD₃;
a polymerization initiator and
a compound, having a different refractive index from that of the polymerizable monomer composition, denoted by a formula (2b); 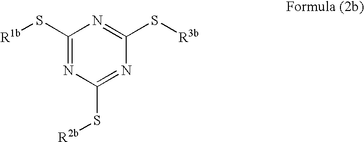
wherein R^{1b}, R^{2b} and R^{3b} respectively denote an optionally substituted alkyl group or an optionally substituted aryl group provided that all of R^{1b}, R^{2b} and R^{3b} aren't simultaneously optionally substituted aryl groups.

12. The polymerizable composition of claim 11 wherein the compound having a different refractive index from that of the polymerizable composition is selected form the group denoted by a formula (3b); 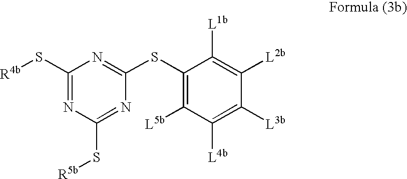
wherein R^{4b} and R^{5b} respectively denote an optionally substituted alkyl group, L^{1b}, L^{2b}, L^{3b}, L^{4b} and L^{5b} respectively denote a hydrogen atom, a halogen atom, an optionally substituted alkyl group, an optionally substituted alkoxy group or an optionally substituted alkylthio group provided that at least two of them denote respectively a halogen atom, an optionally substituted alkyl group, an optionally substituted alkoxy group or an optionally substituted alkylthio group.

13. The polymerizable composition of claim 11 wherein the polymerizable monomer composition contains 5 to 100 weight % of the polymerizable monomer denoted by the formula (1b).

14. The polymerizable composition of claim 11 wherein the polymerizable monomer denoted by the formula (1b) has at least one C-D bond.

15. The polymerizable composition of claim 11 wherein R^{1b}, R^{2b} and R^{3b} in the formula (2b) respectively denote an alkyl group substituted by at least one fluorine atom.

16. An optical member produced by polymerization of a composition of claim 11, so as to form a region having a graded refractive index.

17. The optical member of claim 16 wherein the region having a graded refractive index along the direction from the center to the outside.

18. An optical fiber produced by drawing an optical member of claim 16.
